(19) United States
(12) Patent Application Publication
(10) Pub. No.: US 2025/0278068 A1
(43) Pub. Date: Sep. 4, 2025

(54) SYSTEMS AND METHODS FOR HOME HEALTH MONITORING

(71) Applicant: State Farm Mutual Automobile Insurance Company, Bloomington, IL (US)

(72) Inventors: Christopher N. Otterman, Bloomington, IL (US); Aaron Williams, Congerville, IL (US)

(21) Appl. No.: 18/905,644

(22) Filed: Oct. 3, 2024

Related U.S. Application Data
(60) Provisional application No. 63/560,470, filed on Mar. 1, 2024.

(51) Int. Cl. G05B 19/042

(52) U.S. Cl. CPC G05B 19/0428; G05B 2219/2642

(57) ABSTRACT

A computer system is provided that may be programmed for home monitoring. The system may: (a) receive sensor data from the at least one smart sensor; (b) compare the sensor data to one or more parameters generated using an artificial intelligence model to identify at least one alert condition for the home, wherein the artificial intelligence model is trained based upon historical sensor data relating to a plurality of homes; and/or (c) transmit content data to a user device associated with the home that, when received by the user device, causes the user device to generate a user interface including the identified alert condition.

### CROSS-REFERENCE TO RELATED APPLICATIONS

This application claims the benefit of priority of U.S. Provisional Patent Application No. 63/560,470, filed Mar. 1, 2024, and entitled “SYSTEMS AND METHODS FOR HOME HEALTH MONITORING,” the contents and disclosures of which are hereby incorporated by reference in their entirety.

### FIELD OF THE DISCLOSURE

The field of the disclosure relates generally to home health monitoring, and more specifically, to a smart home computing system for detecting home health issues based upon sensor data.

### BACKGROUND

Issues within a home or other building may not always be easy to detect. These issues may grow worse if not detected and addressed early. For example, (i) a blockage in a dryer vent may be hidden until it becomes a fire hazard; (ii) excessive moisture or humidity may go unnoticed until saturation or mold occurs; (iii) carbon monoxide may go unnoticed until it causes medical symptoms; (iv) pests and insects may cause damage over time that is hidden from view; and/or (v) the efficiency of a heating, ventilation, and air conditioning (HVAC) system may decrease over time until a failure event occurs. A system capable of identifying these issues before they can be observed is therefore desirable. Conventional techniques may include additional inefficiencies, encumbrances, ineffectiveness, and/or other drawbacks as well.

### BRIEF DESCRIPTION

The present embodiments may relate to, inter alia, systems and methods that retrieve sensor data from smart sensors located within homes. This sensor data may be compared to parameters that are generated using a machine learning and/or AI model that predict when certain issues or conditions are present in a home. This model may be trained using historical data retrieved from a large number of homes. Based upon this comparison, the system may determine that certain conditions or issues are likely present in the home, and generate alerts, recommendations, and/or reports that may be presented to associated homeowners and/or other users. The use of the machine learning and/or AI model (and/or other AI and/or machine learning techniques) may be available in various mediums such as a computer and/or mobile application, chat screens, web page, voice interaction with a voice chat-capable connected home device, voice bots or chat bots, ChatGPT bots, and/or social media messaging. The system may include less, or alternate functionality, including that discussed elsewhere herein.

In one aspect, a computer system for home monitoring for a home may be provided. The system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the computer system may be programmed to: (a) receive sensor data from the at least one smart sensor; (b) compare the sensor data to one or more parameters generated using an artificial intelligence model to identify at least one alert condition for the home, wherein the artificial intelligence model is trained based upon historical sensor data relating to a plurality of homes; and/or (c) transmit content data to a user device associated with the home that, when received by the user device, causes the user device to generate a user interface including the identified alert condition. The computer system may include additional, less, or alternate functionality, including that discussed elsewhere herein.

In yet another aspect, a computer-implemented method for home monitoring for a home may be provided. The computer-implemented method may be implemented via one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, computer-implemented method may be performed by a computing device including at least one processor and at least one memory device. The method may include, via the at least one processor: (a) receiving sensor data from the at least one smart sensor; (b) comparing the sensor data to one or more parameters generated using an artificial intelligence model to identify at least one alert condition for the home, wherein the artificial intelligence model is trained based upon historical sensor data relating to a plurality of homes; and/or (c) transmitting content data to a user device associated with the home that, when received by the user device, causes the user device to generate a user interface including the identified alert condition. The method may have additional, less, or alternate actions, including that discussed elsewhere herein.

In still another aspect, at least one non-transitory computer-readable medium having computer-executable instructions embodied thereon may be provided. The computer-executable instructions method may be executed using one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, when executed by at least one processor, the computer-executable instructions cause the at least one processor a to: (a) receive sensor data from the at least one smart sensor; (b) compare the sensor data to one or more parameters generated using an artificial intelligence model to identify at least one alert condition for the home, wherein the artificial intelligence model is trained based upon historical sensor data relating to a plurality of homes; and/or (c) transmit content data to a user device associated with the home that, when received by the user device, causes the user device to generate a user interface including the identified alert condition. The computer-readable medium may have instructions that direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates an exemplary computer system for home monitoring in accordance with the present disclosure.

FIG. 2 illustrates an expanded home monitoring, analysis, and marketplace system including the system of FIG. 1.

FIG. 3 illustrates exemplary source devices that may be used with the systems shown in FIGS. 1 and 2.

FIG. 4 illustrates an exemplary server computing device for use in the systems shown in FIGS. 1 and 2.

FIG. 5 illustrates an exemplary computer system for implementing the systems shown in FIGS. 1 and 2 performing the computer-implemented method shown in FIG. 8.

FIG. 6 depicts an exemplary configuration of a client computer device in accordance with one embodiment of the present disclosure.

FIG. 7 depicts an exemplary configuration of a server computing device in accordance with one embodiment of the present disclosure.

FIG. 8A depicts a flow chart of an exemplary computer-implemented method for home monitoring using the systems shown in FIGS. 1 and 2.

FIG. 8B is a continuation of the flow chart shown in FIG. 8A.

FIG. 8C is a continuation of the flow chart shown in FIGS. 8A and 8B.

FIG. 9 is a diagram illustrating an exemplary data analysis process for home monitoring that may be performed by the systems shown in FIGS. 1 and 2.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, computer systems and computer-based methods that retrieve sensor data from smart sensors located within homes. This sensor data may be compared to parameters that are generated using a machine learning and/or AI model that predict when certain issues or conditions are present in a home. This model may be trained using historical data retrieved from a large number of homes. Based upon this comparison, the system may determine that certain conditions or issues are likely present in the home, and generate alerts, recommendations, and/or reports that may be presented to associated homeowners and/or other users.

In the exemplary embodiment, the system may include a home controller that communicates with at least one smart sensor disposed within a home. The smart sensors may include free-standing devices and/or be incorporated into other devices (e.g., smart appliances), and may include different types of sensors configured to generate corresponding types of sensor data. These sensors may include, for example, airflow sensors, air quality sensors, chemical sensors, humidity sensors, moisture sensors, odor sensors, particulate matter sensors, pressure sensors, temperature sensors, and/or other types of sensors. The sensors may be placed at strategic locations throughout the home (e.g., in HVAC and/or dryer vets, in basements, crawl spaces, and/or attics, near gas lines, pipes, and/or wires, etc.) to collect data proximate to that location. As described in further detail below, combinations of different types of sensor data taken from different locations within the home may be compared to certain predefined parameters to identify alert conditions within the home.

In some embodiments, examples of sensor data that may be captured by the smart sensors may include efficiency of an HVAC system, air duct pressure and speed, exhaust air pressure and speed, HVAC duct air temperature, dryer vent temperature, air quality, air humidity, presence of mold, presence of carbon monoxide, presence of insects or other pests, odor signatures or bad odor detection, particulate matter, pet dander, or other conditions within the home or building.

In the exemplary embodiment, the system may be configured to generate parameters that identify when certain alert conditions are present in a home by querying a machine learning and/or AI model, such as a large language trained generative AI model. This AI model may be trained using historical data relating to historical sensor data. The historical data may include different types of historical sensor data and historical conditions and/or outcomes associated with the historical sensor data. For example, the AI model may define a correlation between historical instances of moisture, mold, animal pests, carbon monoxide, low airflow, duct blockage, high temperature, low temperature, poor air quality, and/or other issues that may occur in a home or building and sensor data or other contextual data that has historically occurred in connection with these issues. Other data considered by the model may include structural details and/or geographic information about the home, household habits or practices of those living in the home, and/or any of the other factors that could be indicative of these issues occurring within a home. This data may be generated by sensors and/or include self-reported data.

In some embodiments, the AI model may be built and/or trained by one or more server computing devices, and parameters output by the AI model and/or the AI model itself may be transmitted to various home controllers for analyzing sensor data of respective homes. Alternatively, in some embodiments, the AI model may be trained by local home controllers. In some embodiments, the system may (e.g., continually) receive further sensor data, based upon which the system may continually and/or periodically update the AI model. As the AI model is updated, the AI model may be used to generate new parameters for analyzing sensor data, which may be transmitted to local home controllers.

In the exemplary embodiment, the system may be configured to compare the sensor data received from smart sensors of a home to one or more of the parameters generated using an artificial intelligence model to identify at least one alert condition for the home. For example, in some embodiments, the parameters may include one or more baseline norms, or expected values or ranges for certain types of sensor data, to which the system may compare the sensor data to identify if any alert conditions or present. These baselines norms may be generated by the AI model based upon historical sensor data.

In various embodiments, certain alert conditions may require a combination of different baseline norms, or that certain length or severity thresholds, or combinations thereof, be met. In one example, the system may determine whether an HVAC system is malfunctioning. If a high humidity compared to the baseline norm is detected but other indicators are normal, the system may not determine there is an issue with the HVAC system. However, if the humidity and temperature are both high compared to the corresponding baseline norms, and the HVAC system is drawing a relatively high amount of power compared to the baseline norm, the system may determine there is an issue with the HVAC system such as a clogged duct, dirty filter, or an electrical or mechanical problem with the HVAC system. In another example, the system may determine whether there is a high risk of mold. If a high humidity compared to the baseline norm is detected, but only for a relatively short period of time, the system may not determine there is a risk of mold absent other indicators. However, if a high humidity compared to the baseline norm is detected for a threshold period of time, the system may determine there is a high risk of mold.

In some embodiments, the parameters may include one or more digital profiles including a plurality of data values corresponding to different types of sensor data, and the system may compare the sensor data to the plurality of data values of the digital profiles to identify the at least one alert condition. For example, a digital profile may be associated with a presence of insects or mold and include a series of expected chemical readings if insects or mold are present. If the sensor data includes chemical readings that match this digital profile, the system may determine that insects or mold are present.

In the exemplary embodiment, the system may be configured to transmit data (referred to herein as “content data”) to a user device associated with the home that, when received by the user device, causes the user device to generate a user interface including any identified alert conditions that are present in the home. For example, the user device may be a mobile device or other computing device capable of executing a mobile application (“apps”) that causes the user interface to display. In addition to any identified alert conditions, the user interface may also display other data and recommendations. For example, the user interface to display numbers, indicators, or graphics representing at least some of the received sensor data, which may illustrate outliers in senor data, locations of detected issues, graphs of norms and current levels, trends over time, comparisons to thresholds considered safe or normal, and comparisons to other homes (e.g., averages in a neighborhood and/or geographic area of the homes). In some such embodiments, this data may be continuously or periodically updated to reflect real time conditions within the home.

In some embodiments, the system may be configured to generate at least one recommendation based upon the identified alert condition and cause the user interface to display the generated recommendation. In some embodiments, a database may include a predefined relationship between certain conditions that may be identified and corresponding recommendations, and when a certain condition is identified, a lookup may be performed to retrieve and display the corresponding recommendation. In some embodiments, AI or chatbots may be used to generate recommendations. An output of the AI or chatbot may include computer executable instructions for generating a user interface (e.g., within the app and/or web page) to present the recommendations. The use of the generative AI model may be available in various mediums such as a computer and/or mobile application, chat screens, web page, voice interaction with a voice chat-capable connected home device, voice bots or chat bots, ChatGPT bots, and/or social media messaging. In some embodiments, the system may generate reports (e.g., on demand or periodically) indicating any issues that were identified and remedies taken, which may be provided to potential buyers of the home or other parties such as insurers.

In certain embodiments, the system may be configured to generate and provide recommendations for placement of sensors within the home. In such embodiments, the system may receive data relating to the home (sometimes referred to herein as “home data”). This data may be input by a user and/or retrieved from other sources. For example, the system may generate a form, prompt, and/or survey via the user interface, through which the homeowner may input information about the home such as a layout of the home, types of appliances, devices, or other systems in the home, building materials used (e.g., for roof, siding, insulation, etc.), and locations of, pipes ducts, or other relevant components of the home. In some embodiments, this input may include images captured by the user, and the system may provide instructions for capturing these images (e.g., via the app).

Based upon this home data, the system may generate at least one recommendation for placing smart sensors within the home cause the user interface to display the generated recommendation. The system may train a machine learning and/or AI model, such as a large language trained generative AI (e.g., ChatGPT) model, using historical home data, such as home data relating to (e.g., a large number of) other homes and confidence outcomes (e.g., how well certain sensor configurations are able to identify conditions in the home with confidence) associated with this historical home data.

In some embodiments, the system (e.g., using an AI model) may search for products, stores, and/or services relating to the recommendations and, in some such embodiments, provide a link (e.g., a hyperlink) to the recommended products, stores, and/or services to the user via a computing device (e.g., via a mobile application, web page, and/or email). For example, the links may relate to products and/or maintenance services that may address alert conditions and/or other issues identified in the home. The system may use geolocation to determine appropriate products, stores, or home services located near, at, or around the vicinity of the user's geolocation, which the homeowner may purchase in order to implement recommendations provided by the system.

In some embodiments, the recommendations may include a schedule of actions and/or a curated plan and set of reminders for when certain actions should be performed. The recommendations may include a list of actions to address potential issues identified in the home. In certain embodiments, recommendations may include a timeline and/or a recommended order for performing these actions.

The recommendation list may be presented through a user interface that enables the homeowner to select and/or click on listed actions to automatically purchase and/or schedule products and/or services associated with the actions. For example, if a clogged dryer vent is identified, the system may provide a link to a dryer vent cleaning service and/or to purchase tools that may be used to clean the dryer vent. In some embodiments, the recommendation may further indicate potential cost savings (e.g., energy savings) that may result from performing a certain recommended action.

The system may further provide additional information relating to the recommended actions, such as advantages of the particular actions, costs, potential cost savings (e.g., reducing insurance and/or energy costs), when and how to perform the actions, and/or alternative options. In some embodiments, the recommendations may be generated in response to query by the homeowner and/or may be periodically generated automatically (e.g., as a monthly report to the homeowner).

In some embodiments, the system may be communicably coupled to a communication network and/or a financial services provider. The system may receive insurance information from the financial services provider. The system may connect an insurance policy of the homeowner to the generated recommendations, in which the application may display potential changes to the homeowner's insurance policy based upon, for example, installation of smart sensors in the home, a presence of certain conditions, and/or implementation of recommendations that fix and/or otherwise mitigate these conditions. The system may prioritize the recommendations based upon potential changes to a customer's insurance policy or claims information submitted by other customers living in an area geolocated near the homeowner.

In some embodiments, the system may include a risk evaluation engine that may sensor data associated with a home to evaluate various risks associated with the home. For example, sensor data patterns or profiles may correlate to a certain level of risk of damage occurring to the home. The system may use numerous data points to evaluate such risks to a residential property and may compute a composite risk score and/or various focused risk scores for the property. The risk score (e.g., or likelihood of damage score) may be a numeric value and/or a category (e.g., excellent, good, fair, and poor). Such risk scores may be used, for example by an insurance provider, to evaluate insurability of the property and its assets, to price insurance policy options for the property, or to provide policy discounts and verify compliance for risk mitigating changes, actions, or behaviors. Further, such risk scores may be used to determine to recommend actions (e.g., maintenance) be taken.

In some embodiments, the system may generate a risk score for different categories of risk, such as property risk, fire protection, and safety, which may be presented individually within the user interface with related recommendations. For example, the fire protection rating may be displayed along with fire-protection related recommendations, such as recommendation relating to actions that may result in a reduction of fire risk if implemented (e.g., addressing alert conditions identified by the system that relate to fire safety).

While various examples provided herein describe application of the system to various aspects of home appliances and other home systems, the systems and methods described herein may also be used for performing other analysis, such as vehicles, businesses, municipal locations, and/or other locations and/or items.

### Exemplary System for Home Monitoring

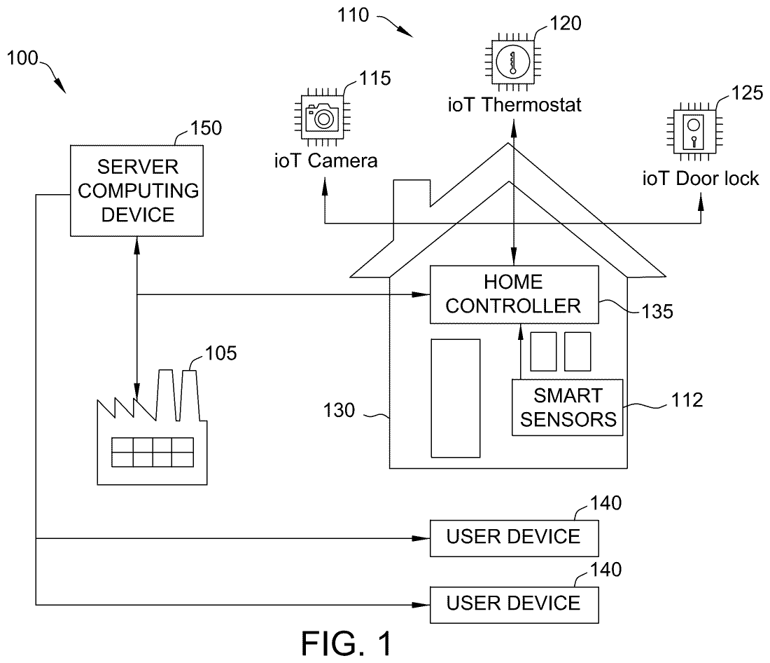

FIG. 1 illustrates an exemplary computer system 100 for monitoring and analyzing homes, in accordance with at least one embodiment of this disclosure. System 100 illustrates monitoring and other devices to receive, analyze, and report the data collected about the home.

In the exemplary embodiment, a manufacturer server 105 provides one or more IoT devices 110, also known as IoT devices 110, and/or smart sensors 112. These IoT devices 110 and/or smart sensors 112 may be positioned in or around a home 130. IoT devices 110 may include, but are not limited to IoT cameras 115, IoT thermostats 120, IoT door locks 125, and/or any other internet connected device, including, but not limited to, user devices 140, which may be mobile devices, laptops, and/or a mobile phones, one or more voice or chat bots, a computer device, including, but not limited to, a desktop computer and/or a router, and/or a home controller 135.

In at least one embodiment, the home controller 135 is in wired or wireless communication the one or more IoT devices 110 and smart sensors 112 in home 130. In some embodiments, the home controller 135 may be a router or Wi-Fi providing device in the home 130. In other embodiments, the home controller 135 is a smart home controller that controls one or more of IoT devices 110 and/or smart sensors 112 and may provide communication between the user and the individual IoT devices 110 and/or smart sensors 112.

In some embodiments, each IoT device 110 and/or smart sensors 112 may collect data about the home either directly or indirectly. For example, a smart light bulb may report when the bulb is on and off. This may indirectly indicate whether or not an individual is near the bulb. In the at least one embodiment, many IoT devices 110 and/or smart sensors 112 are in communication with one or more servers of the manufacturer server 105. The manufacturer server 105 may provide additional services, such as remote activation. The manufacturer server 105 may also collect data observed by IoT device 110 and/or smart sensors 112, including, but not limited to, usage data about IoT device 110.

In some embodiments, a server computing device 150 may be in communication with one or more of the IoT devices 110, smart sensors 112 the home controller 135, and/or the manufacturer servers 105. Server computing device 150 may collect data from IoT devices 110 and/or smart sensors 112 for use in identifying potential alert conditions or other issues in home 130 and generating corresponding scores and/or recommendations. Server computing device 150 may be in communication with one or more user devices 140 associated with respective homeowners, though which server computing device 150 may present alerts, sensor data, scores and/or recommendations, as described in further detail below.

In certain embodiments, smart sensors 112 may include free-standing devices and/or be incorporated into other devices (e.g., IoT devices 110) and may include different types of sensors configured to generate corresponding types of sensor data. These sensors may include, for example, airflow sensors, air quality sensors, chemical sensors, humidity sensors, moisture sensors, odor sensors, particulate matter sensors, pressure sensors, temperature sensors, and/or other types of sensors. Smart sensors 112 may be placed at strategic locations throughout home 130 (e.g., in HVAC and/or dryer vets, in basements, crawl spaces, and/or attics, near gas lines, pipes, and/or wires, etc.) to collect data proximate to that location. As described in further detail below, combinations of different types of sensor data taken from different locations within home 130 may be compared to certain predefined parameters to identify alert conditions within home 130.

In various embodiments, examples of sensor data that may be captured by smart sensors 112 may include efficiency of an HVAC system, air duct pressure and speed, exhaust air pressure and speed, HVAC duct air temperature, dryer vent temperature, air quality, air humidity, presence of mold, presence of carbon monoxide, presence of insects or other pests, odor signatures or bad odor detection, particulate matter, pet dander, or other conditions within the home or building.

In the exemplary embodiment, server computing device 150 and/or home controller 135 may be configured to generate parameters that identify when certain alert conditions are present in a home by querying a machine learning and/or AI model, such as a large language trained generative AI model. This AI model may be trained using historical data relating to historical sensor data.

The historical data may include different types of historical sensor data and historical conditions and/or outcomes associated with the historical sensor data. For example, the AI model may define a correlation between historical instances of moisture, mold, animal pests, carbon monoxide, low airflow, duct blockage, high temperature, low temperature, poor air quality, and/or other issues that may occur in a home or building and sensor data or other contextual data that has historically occurred in connection with these issues. Other data considered by the model may include structural details and/or geographic information about the home, household habits or practices of those living in the home, and/or any of the other factors that could be indicative of these issues occurring within a home. This data may be generated by sensors and/or include self-reported data.

In some embodiments, the AI model may be built and/or trained by server computing device 150, and parameters output by the AI model and/or the AI model itself may be transmitted to home controller 135 for analyzing sensor data of respective homes. Alternatively, in some embodiments, the AI model may be trained and/or executed locally by home controller 135. In some embodiments, server computing device 150 and/or home controller 135 may (e.g., continually) receive further sensor data, based upon which server computing device 150 and/or home controller 135 may continually and/or periodically update the AI model. As the AI model is updated, the AI model may be used to generate new parameters for analyzing sensor data, which may be transmitted to home controller 135.

In the exemplary embodiment, server computing device 150 and/or home controller 135 may be configured to compare the sensor data received from smart sensors 112 of home 130 to one or more of the parameters generated using an artificial intelligence model to identify at least one alert condition for the home. For example, in some embodiments, the parameters may include one or more baseline norms, or expected values or ranges for certain types of sensor data, to which server computing device 150 and/or home controller 135 may compare the sensor data to identify if any alert conditions or present. These baselines norms may be generated by the AI model based upon historical sensor data.

In some embodiments, certain alert conditions may require a combination of different baseline norms, or that certain length or severity thresholds, or combinations thereof, be met. In one example, server computing device 150 and/or home controller 135 may determine whether an HVAC system is malfunctioning. If a high humidity compared to the baseline norm is detected but other indicators are normal, the system may not determine there is an issue with the HVAC system. However, if the humidity and temperature are both high compared to the corresponding baseline norms, and the HVAC system is drawing a relatively high amount of power compared to the baseline norm, the system may determine there is an issue with the HVAC system such as a clogged duct, dirty filter, or an electrical or mechanical problem with the HVAC system. In another example, server computing device 150 and/or home controller 135 may determine whether there is a high risk of mold. If a high humidity compared to the baseline norm is detected, but only for a relatively short period of time, the system may not determine there is a risk of mold absent other indicators. However, if a high humidity compared to the baseline norm is detected for a threshold period of time, the system may determine there is a high risk of mold.

In some embodiments, the parameters may include one or more digital profiles including a plurality of data values corresponding to different types of sensor data, and the system may compare the sensor data to the plurality of data values of the digital profiles to identify the at least one alert condition. For example, a digital profile may be associated with a presence of insects or mold and include a series of expected chemical readings if insects or mold are present. If the sensor data includes chemical readings that match this digital profile, server computing device 150 and/or home controller 135 may determine that insects or mold are present.

In the exemplary embodiment, the system may be configured to transmit data (referred to herein as “content data”) to a user device 140 associated with home 130 that, when received by user device 140, causes user device 140 to generate a user interface including any identified alert conditions that are present in the home. For example, user device 140 may be a mobile device or other computing device capable of executing an app that causes the user interface to display. In addition to any identified alert conditions, the user interface may also display other data and recommendations. For example, the user interface to display numbers, indicators, or graphics representing at least some of the received sensor data, which may illustrate outliers in senor data, locations of detected issues, graphs of norms and current levels, trends over time, comparisons to thresholds considered safe or normal, and comparisons to other homes (e.g., averages in a neighborhood and/or geographic area of the homes). In some such embodiments, this data may be continuously or periodically updated to reflect real time conditions within the home.

In some embodiments, server computing device 150 and/or home controller 135 may be configured to generate at least one recommendation based upon the identified alert condition and cause the user interface to display the generated recommendation. In some embodiments, a database may include a predefined relationship between certain conditions that may be identified and corresponding recommendations, and when a certain condition is identified, a lookup may be performed to retrieve and display the corresponding recommendation. In some embodiments, AI or chatbots may be used to generate recommendations. An output of the AI or chatbot may include computer executable instructions for generating a user interface (e.g., within the app and/or web page) to present the recommendations.

The use of the generative AI model may be available in various mediums such as a computer and/or mobile application, chat screens, web page, voice interaction with a voice chat-capable connected home device, voice bots or chat bots, ChatGPT bots, and/or social media messaging. In some embodiments, server computing device 150 and/or home controller 135 may generate reports (e.g., on demand or periodically) indicating any issues that were identified and remedies taken, which may be provided to potential buyers of the home or other parties such as insurers.

In some embodiments, server computing device 150 and/or home controller 135 may be configured to generate and provide recommendations for placement of sensors within home 130. In such embodiments, the system may receive home data. This data may be input by a user and/or retrieved from other sources. For example, server computing device 150 and/or home controller 135 may generate a form, prompt, and/or survey via the user interface, through which the homeowner may input information about home 130 such as a layout of the home, types of appliances, devices, or other systems in the home, building materials used (e.g., for roof, siding, insulation, etc.), and locations of, pipes ducts, or other relevant components of the home. In some embodiments, this input may include images captured by the user, and server computing device 150 and/or home controller 135 may provide instructions for capturing these images (e.g., via the app).

Based upon this home data, server computing device 150 and/or home controller 135 may generate at least one recommendation for placing smart sensors within the home cause the user interface to display the generated recommendation. Server computing device 150 and/or home controller 135 may train a machine learning and/or AI model, such as a large language trained generative AI (e.g., ChatGPT) model, using historical home data, such as home data relating to (e.g., a large number of) other homes and confidence outcomes (e.g., how well certain sensor configurations are able to identify conditions in the home with confidence) associated with this historical home data.

In some embodiments, server computing device 150 and/or home controller 135 (e.g., using an AI model) may search for products, stores, and/or services relating to the recommendations and, in some such embodiments, provide a link (e.g., a hyperlink) to the recommended products, stores, and/or services to the user via a computing device (e.g., via a mobile application, web page, and/or email). For example, the links may relate to products and/or maintenance services that may address alert conditions and/or other issues identified in the home. Server computing device 150 and/or home controller 135 may use geolocation to determine appropriate products, stores, or home services located near, at, or around the vicinity of the user's geolocation, which the homeowner may purchase in order to implement recommendations provided by the system.

In some embodiments, the recommendations may include a schedule of actions and/or a curated plan and set of reminders for when certain actions should be performed. In some embodiments, the recommendations may include a list of actions to address potential issues identified in the home. In some embodiments, recommendations may include a timeline and/or a recommended order for performing these actions.

The recommendation list may be presented through a user interface that enables the homeowner to select and/or click on listed actions to automatically purchase and/or schedule products and/or services associated with the actions. For example, if a clogged dryer vent is identified, the user interface may include a link to a dryer vent cleaning service and/or to purchase tools that may be used to clean the dryer vent. In some embodiments, the recommendation may further indicate potential cost savings (e.g., energy savings) that may result from performing a certain recommended action.

In various embodiments, server computing device 150 and/or home controller 135 may further provide additional information relating to the recommended actions, such as advantages of the particular actions, costs, potential cost savings (e.g., reducing insurance and/or energy costs), when and how to perform the actions, and/or alternative options. In some embodiments, the recommendations may be generated in response to query by the homeowner and/or may be periodically generated automatically (e.g., as a monthly report to the homeowner).

In some embodiments, server computing device 150 and/or home controller 135 be communicably coupled to a communication network and/or a financial services provider. Server computing device 150 and/or home controller 135 may receive insurance information from the financial services provider. Server computing device 150 and/or home controller 135 may connect an insurance policy of the homeowner to the generated recommendations, in which the application may display potential changes to the homeowner's insurance policy based upon, for example, installation of smart sensors in the home, a presence of certain conditions, and/or implementation of recommendations that fix and/or otherwise mitigate these conditions. Server computing device 150 and/or home controller 135 may prioritize the recommendations based upon potential changes to a customer's insurance policy or claims information submitted by other customers living in an area geolocated near the homeowner.

In some embodiments, server computing device 150 and/or home controller 135 may include a risk evaluation engine that may evaluate data associated with sensor data in a home to evaluate various risks associated with the home. For example, sensor data patterns or profiles may correlate to a certain level of risk of damage occurring to the home. Server computing device 150 and/or home controller 135 may use numerous data points to evaluate such risks to a residential property and may compute a composite risk score and/or various focused risk scores for the property.

The risk score (e.g., or likelihood of damage score) may be a numeric value and/or a category (e.g., excellent, good, fair, and poor). Such risk scores may be used, for example by an insurance provider, to evaluate insurability of the property and its assets, to price insurance policy options for the property, or to provide policy discounts and verify compliance for risk mitigating changes, actions, or behaviors. Further, such risk scores may be used to determine to recommend actions (e.g., maintenance) be taken.

In some embodiments, server computing device 150 and/or home controller 135 may generate a risk score for different categories of risk, such as property risk, fire protection, and safety, which may be presented individually within the user interface with related recommendations. For example, the fire protection rating may be displayed along with fire-protection related recommendations, such as recommendation relating to actions that may result in a reduction of fire risk if implemented (e.g., addressing alert conditions identified by the system that relate to fire safety).

### Exemplary Home Monitoring System

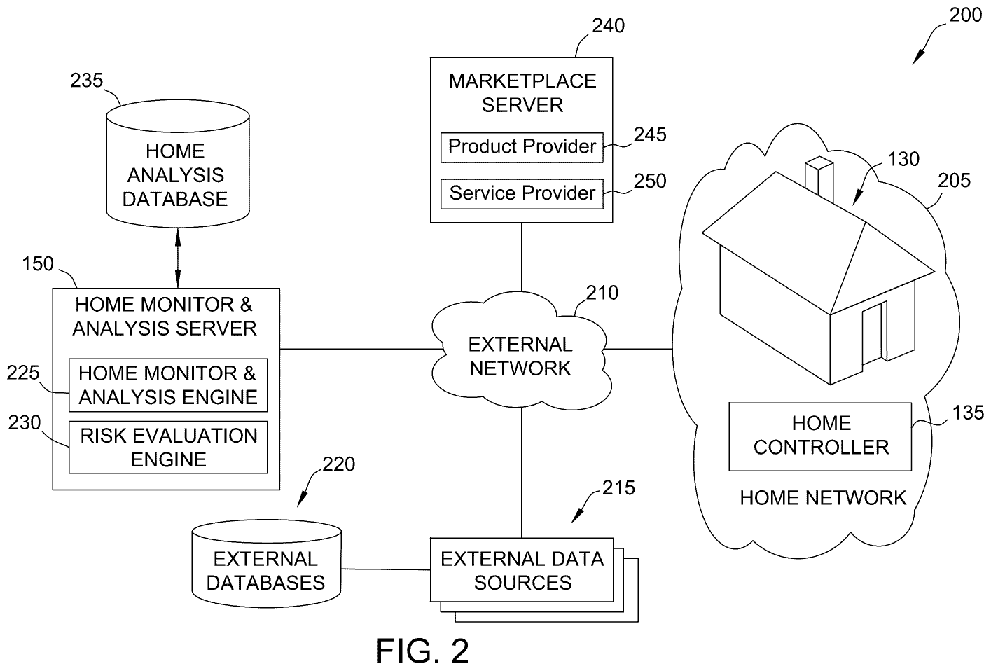

FIG. 2 illustrates an expanded computer system 200 that may be used for identifying conditions in home 130 and providing recommendations for improving addressing these identified conditions. In the exemplary embodiment, the system 200 includes server computing device 150 that may be remote from the home. Server computing device 150 may be configured to execute a home monitor and analysis engine 225 and a risk evaluation engine 230. The server computing device 150 may include or otherwise be in communication with a home analysis database 235 that stores information about the home 130 that may be used in part to identify conditions or issues in home 130, and may include information about real estate upon which the home 130 is located, assets contained within the home 130, and various data points that may be used to determine if any alert conditions or issues are present in home 130. The terms “house,” “home,” and “residential property” may be used interchangeably herein to refer to the home 130 and its various property and assets.

In the exemplary embodiment, the server computing device 150 is in networked communication with a home controller (or just “controller”) 135 of the home 130 through an external network 210 (e.g., the Internet). The home controller 135 may manage aspects of sensor data collection, computations, and alerting as a part of system 100. The home controller 135 is connected to a home network 205 of the home 130 which allows communication with server computing device 150 through an external network 210 (e.g., the Internet). For example, the home 130 may include a local area network (“LAN”), a wireless network (e.g., Wi-Fi network), or some combination thereof that connects to the external network 210 (e.g., via a subscription service to an Internet service provider, or the like). In some embodiments, the home controller 135 may communicate via a wireless mobile network, such as a 3G, 4G, or 5G network.

The home network 205 may allow various devices within the home 130 to communicate over the home network 205, such as computing devices and Internet-of-Things (“IoT”) type devices 110 and/or smart sensors 112 (shown in FIG. 1). Such IoT devices 110 and/or smart sensors 112 may be referred to herein as “connected home devices,” in that they are associated with the home 130 or otherwise a part of the home network 205. Some IoT devices 110 and/or smart sensors 112 may participate in system 100 and/or system 200, for example, providing sensor data that may be used (e.g., by server computing device 150) to evaluate home 130, to generate risk scores, determine matches in the marketplace server 240, or other uses described herein.

In the exemplary embodiment, the systems 100 and 200 may allow homeowners to opt into or out of various aspects of data collection from IoT devices 110 (e.g., by device type, by type of data collected, by data use). For example, the homeowner may be presented with an individual login to the system 100 and 200 which may include an opt-in screen that allows the homeowner to view data collection and usage policy and select whether they wish to allow such usage, thereby protecting privacy of the homeowner. Home data generated by such IoT devices 110 may be referred to herein as just “home data.” In some embodiments, the sensor data analyzed by the system may include and/or be a subset of this home data.

Server computing device 150, in the exemplary embodiment, may collect some home data from one or more external data sources 215. The home monitor and analysis engine 225 or the risk evaluation engine 230 may, for example, collect data from publicly available sources or from private third-party sources about the particular subject home 130 or the area in which the home 130 is built (referred to herein as “the locality of the home”). For example, one external data source 215 may be the national weather service (“NWS”), a branch of the national oceanic and atmospheric administration (“NOAA”). The NWS collects, and makes publicly available, weather data for the United States of America and its outlying countries.

The system 100 and 200 may collect aspects of historical, current, or predictive weather data for a locality of the home 130 (e.g., storm, wind, lightning, flooding in the locality) and may use such data to, for example, evaluate the appliances installed in home 130. Such data from external data sources 215 is referred to herein as “external data.” Some external data sources 215 may maintain such external data in one or more external databases 220. Other examples of external data sources 215 and external data may be provided by manufacturer server 105 (shown in FIG. 1) in addition to those provided below, as well as various uses for such external data.

In the exemplary embodiment, server computing device 150 is in communication with a marketplace server 240 through the external network 210. The marketplace server 240 is a platform where businesses and/or individuals come together to sell products and services to the customer base of homeowners. The marketplace server 240 and server computing device 150 determine the needs of the users and then determines which product providers 245 (e.g., stores or individuals who have listed products for sale) and service providers 250 that may be of assistance to the user. For example, if an appliance or other device needs to be repaired or upgraded, server computing device 150 may identify a service provider 250 that can perform the needed repair or upgrade and provide a link to communicate with the service provider 250 to the homeowner (e.g., using user device 140). Similarly, if an appliance or other device needs to be replaced, server computing device 150 may identify a product provider 245 that can provide a replacement and provide a link to communicate with the product provider 245.

In the exemplary embodiment, server computing device 150 may be operated by an insurance provider that provides insurance coverage for the home 130 (e.g., via a home insurance policy) or that provides participation in systems 100 and 200 as a home protection service for the homeowner. The insurance provider may be any individual, group of individuals, company, corporation, or other type of entity that may issue insurance policies for customers, such as a homeowners, renters, or personal articles insurance policy associated with the home 130 or an insured. For example, after signing up for a home insurance coverage, the insurance provider may provide the home controller 135 for installation in the home 130.

Although the present disclosure describes the systems and methods as being facilitated in part by the insurance provider, it should be appreciated that other non-insurance related entities may implement the systems and methods. For example, a utility company, government or public policy organization, manufacturer and/or general contractor may aggregate the sensor data across many properties to determine which products and/or home configurations provide the best energy efficiency. Accordingly, it may not be necessary for the home 130 to have an associated insurance policy for the property owners to enjoy the benefits of the systems and methods.

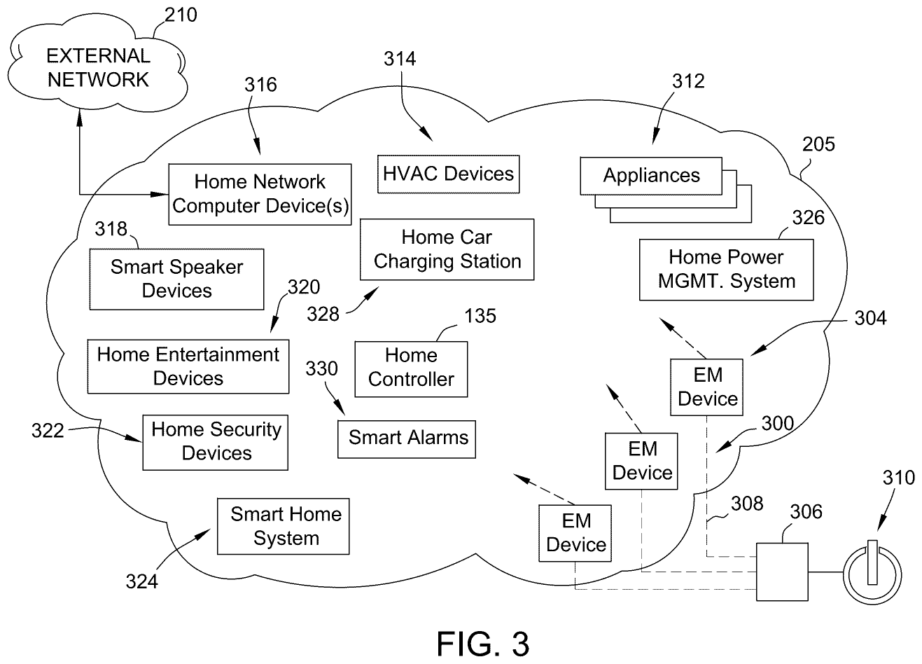

The home controller 135, as discussed in greater detail below, may be configured to collect home data, such as sensor data, from sensors, appliances, or other devices within the home 130, connect to the home network 205, and communicate with server computing device 150 and/or marketplace server 240. The home controller 135 may be configured to connect to the home network 205 and communicate with other networked IoT devices 110 (or “smart devices”) and/or smart sensors 112 within the home 130. Such IoT devices 110 and/or smart sensors 112 may be referred to herein as “source devices,” “connected devices,” or “IoT devices,” as devices that provide home data to the systems 100 and 200. In some embodiments, server computing device 150 may communicate directly with some or all of the source IoT devices 110 and/or smart sensors 112 within the home 130. Various source devices are illustrated in further detail below with respect to FIG. 3.

In the exemplary embodiment, server computing device 150 provides the users access to the marketplace, while using ML and AI to determine which product providers 245 and service providers 250 are the most relevant to the user based upon the analysis of home 130. In at least some embodiments, server computing device 150 determines different attributes and/or conditions of the devices in home 130 based upon the home data provided from IoT devices 110 and/or the external data sources 215.

### Exemplary Source Devices

FIG. 3 illustrates exemplary source devices that may be used with the system 100 (shown in FIG. 1) and the system 200 (shown in FIG. 2). In the exemplary embodiment, the home controller 135 is in communication with or otherwise monitors or collects data from a variety of source devices within the home network 205. The home 130, and the various source devices therein, may be powered by an electrical distribution system 300. Paths of electrical power flow are illustrated in FIG. 3 in broken lines. The electrical distribution system 300 includes multiple electrical circuits 308, each of which may provide power to one or more of the source devices or other IoT devices 110 within the home 130. Each of the example circuits 308 emanate from an electrical distribution panel 306 that receives power from a power source 310, such as a utility power company or an on-premise power source (e.g., gas generator, solar generator, wind generator). Each circuit 308 may include a circuit breaker for each circuit 308 in the electrical distribution panel 306. While not expressly shown, any of the various source IoT devices 110 and/or smart sensors 112 (not shown in FIG. 3) may be connected to and powered by the electrical circuits 308.

In the exemplary embodiment, the systems 100 and 200 may include one or more electricity monitoring (“EM”) devices 304. EM devices 304 may be used to monitor electricity flowing to individual electric devices, such as smart devices or appliances, electronics, vehicles, or mobile devices, and may be configured to monitor or detect abnormal usage or trends. Abnormal electricity flow (“EF”) to various devices may indicate that failure is imminent, maintenance or device replacement is needed, de-energization is recommended, or other corrective actions are prudent. For example, the EM devices 304 may be TING® smart sensors such as those made commercially available by Whisker Labs of Germantown, MD.

EF data collected by the EM devices 304 may include data indicative of electricity flow to or from various smart or other IoT devices 110, including the various devices shown here in FIG. 3. EF data may also include electricity or energy usage for each electronic component, device, outlet, circuit, or the like, within the home 130, such as data indicating the electricity each device or room is using. For example, energy usage of air conditioners, washers, dryers, dish washers, refrigerators, stoves, ovens, microwave ovens, televisions, lamps, outlets, computers, laptops, mobile devices, other electronic devices, may be determined by the EM device 304.

In addition to energy usage, EF data may be used to detect hazards or other abnormalities that may be correlated with a reduced energy efficiency of the powered appliances and/or indicate a risk to the home 130 or its assets. For example, changes in electrical consumption (e.g., drawing more power and/or current than usual) of IoT devices 110 may indicate that IoT devices 110 are having problems that may influence an energy efficiency of IoT devices 110. Accordingly, EF data collected by the EM devices may be fed into the AI model as a factor in determining energy efficiency and generating recommendations to improve the energy efficiency.

EM devices 304 may include sensors that are configured to monitor and collect EF data. EM devices 304 may be plugged into electrical outlets within the home (e.g., conventional 110-volt outlets) for at least powering the EM device 304 and/or IoT devices 110, or may be electrically wired into a circuit 308 for powering the EM device 304 and/or IoT devices 110. Further, some EM devices 304 may collect EF data directly from a circuit 308 (e.g., via wired connection to the circuit 308, referred to herein as “direct sensing”) and some EM devices 304 may wirelessly collect EF data from circuits 308, appliances, or other electricity consuming devices (referred to herein as “wireless sensing”).

Wireless sensing may include, for example, sensors within the EM device 304 that are configured to sense electromagnetic waves or an electrical signature of the electrical devices receiving power from the electrical distribution system 300. The EM devices 304 may directly or wirelessly detect each flow of electricity to or from each different electronic device by identifying each electronic device by its unique electronic or electrical signature (or “fingerprint”). The EM devices 304 may then generate electricity usage or flow data for each electronic device within the home, or connected to the electrical distribution system 300 (such as a hybrid or fully electric vehicle having its battery directly or wirelessly charged by the home's electrical system). In some embodiments, EM devices 304 may be positioned in vicinity of the electrical distribution panel 306 and may capture electrical activity about the home 130 and/or devices installed in the home 130 by wirelessly detecting an electricity flow to devices that are coupled to the electrical distribution panel 306.

In other embodiments, EM devices 304 may be positioned in vicinity of the electrical distribution panel 306, but not hardwired to the electrical distribution panel 306 or home electrical wiring system, and may capture electrical activity about the home 130 and/or appliances installed in the home 130 by wirelessly detecting an electricity flow to devices that are coupled to the electrical distribution panel 306. In other embodiments, EM devices 304 may be plugged into electrical outlets positioned throughout a home.

During operation, as one or more of the electric devices receives electricity via the electrical distribution system 300, each device may be differentiated by an electrical signature that is unique to a respective device (such as by one or more EM devices 304 monitoring, detecting, and/or analyzing the electricity flowing to or being consumed by each respective electric device, and/or by monitoring EF data generated or collected by one or more EM devices 304).

In other words, transmission of electricity to a refrigerator, for example, may be differentiated from transmission of electricity to an electric stove (such as via one or more EM devices 304 and/or analyzing the EF data generated or collected by one or more EM devices 304). Furthermore, transmission of electricity to a television on one circuit 308 or outlet, for example, may be differentiated from transmission of electricity to another recipient electric device (e.g., a cable television box) via the same circuit 308 or electrical outlet. The systems 100 and 200 may correlate electrical activity with a variety of electric devices on the electrical distribution system 300 based upon electrical signatures unique to each respective device. The systems 100 and 200 may build a structural electrical profile for the home 130, which may include data indicative of operation of the various electric devices within or around the home 130 (e.g., over a period of time), such as by using EF data generated or collected by one or more EM devices 304 over a period of time. In some embodiments, the electrical profile may further be used in identifying specific models of appliances to be added to the digital home profile.

In some embodiments, an EM device 304 may be affixed to or situated near the electrical distribution panel 306. Generally, the EM device 304 may utilize the unique, differentiable electrical signatures of the electric devices by directly or wirelessly monitoring electrical activity including transmission of electricity via the electrical distribution panel 306 to one or more of the electric devices. Monitoring of transmission of electricity to an electric device receiving the electricity may include, for example, monitoring (i) the time at which the electricity was transmitted, (ii) the duration for which the electricity was transmitted, and/or (iii) the magnitude of the electric current in the transmission.

Based upon the unique electrical signatures of the various electric devices of the home 130, the monitored electrical activity may be correlated with respective electric devices receiving the electricity transmitted via the electrical distribution system 300, enabling the electricity usage of the various devices to be tracked individually. Further, electrical activity associated with other components of the electrical distribution system 300 (e.g., the electrical distribution panel 306, the circuits 308, or the like) may be correlated with one or more electric devices to which the electrical activity also pertains.

In some embodiments, the EM device(s) 304 may perform the correlation or other functions described herein, via one or more processors of the EM device(s) 304 that may execute instructions stored at one or more computer memories of the EM devices 304. In other embodiments, the EM devices 304 may collect the EF data, and the correlation and/or other functions described herein may be performed at another system (e.g., the home controller 135 or server computing device 150), which may receive data or signals indicative of monitored electricity or other data via one or more processors or through transfer via a physical medium (e.g., a USB drive). Correlation of the electrical activity with the respective electrical devices may produce data indicating, for example, the time, duration, and/or magnitude of electricity consumption by each of the electric devices during a period of electrical activity monitoring.

Based upon at least the correlated electrical activity, a structure electrical profile may be built and stored at the EM devices 304 or at some other system (e.g., the home controller 135 or the home analysis database 235). The structure electrical profile may include, for each of the electric devices about the home 130, data indicative of operation of the respective electric device during at least the period at which the EM devices 304 monitored electrical activity about the home 130. Based upon the correlated electrical activity, the structure electrical profile may depict, for example, average electricity operation/usage, baseline electricity operation/usage, and/or expected electricity operation/usage/consumption. In effect, the structure electrical profile, based upon electrical activity about the structure, may set forth what is “normal” operation and usage of electricity about the structure.

Thus, once the structure electrical profile is built, any electrical activity monitored via the home controller 135 and the EM device(s) 304 may be analyzed to determine whether electrical activity is abnormal and/or otherwise indicative of a condition that my affect the energy efficiency of the electric devices. In response to the abnormal electrical activity, among other possible factors, corrective actions to improve the energy efficiency of the device, mitigate damage, prevent damage, and/or remedy the cause of the abnormal electrical activity the situation may be determined and/or initiated. Some possible corrective actions are discussed herein.

EF data regarding an electric device may include, for example, historical data indicating the electric device's past operation patterns or trends. For example, historical data may indicate a time of day, day of the week, time of the month, etc., at which an electric device frequently uses electricity (e.g., a lighting fixture may not use electricity during late night hours of the day). As another example, historical data may include the electric device's total electricity consumption or usage rate over a period of time. Additionally or alternatively, historical data may include data indicating past events regarding the electric device (e.g., breakdowns, power losses, arc faults, etc.).

Additionally or alternatively, operation data regarding an electric device may include an expected electricity consumption or baseline electricity consumption for the electric device. For example, in the case of a refrigerator, the refrigerator's electricity consumption during a first period of monitoring may be reliably used to approximate an expected electricity consumption at a later time. Changing electricity consumption over time (e.g., the refrigerator's consumption is greater than expected for a period) may indicate that the refrigerator is in need of repair and/or maintenance and/or operating sub-optimally.

Further, the structure electrical profile may include data pertaining to the structure as a whole. For example, the structure electrical profile may include data reflecting a total electricity or average usage rate over a period of time. As another example, the profile may include time-of-day, day-of-week, etc., data reflecting times at which the home 130 as a whole uses more or less electricity. Further, the profile may detail specific types, classes, or specifications of electric devices that behave differently or consume a different amount of electricity compared to other electric devices within the home 130. Further, the profile may detail specific risks determined to be relevant to one or more of the electric devices or to the home 130 as a whole, based upon the electrical activity of the electric devices.

Furthermore, the structure electrical profile may include a digital “map” of the home 130. A home map may indicate spatial locations of the electric devices, and/or spatial relationships between two or more of the electric devices. Such mapping may indicate, for example, energy efficiency implications and/or a risk associated with the spatial placement of a stove, and/or energy efficiency implications and/or a risk associated with placing a refrigerator adjacent to the stove. Additionally or alternatively, the home map may indicate which of the electric devices are connected to each electrical circuit 308 within the electrical distribution system 300 of the home 130. Such mapping may indicate, for example, a risk of overloading a particular circuit 308 based upon a number or intensity of electric devices connected to the circuit 308. As another example, the home map may be used to determine what electric devices may lose power if a particular circuit 308 were to be de-energized (e.g., due to risk or abnormal electrical activity associated with one electric device on the circuit).

In some embodiments, the home map may be configurable by a user (e.g., the homeowner of the home 130). The user may, for example, configure the map via an I/O module (e.g., screen, keypad, mouse, voice control, etc.) of the home controller 135, or via an I/O module of another computing device, which may transmit the home map to the home controller 135. Additionally or alternatively, the home map may be stored at one or more computer memories of another system (e.g., server computing device 150).

In some embodiments, the home network 205 may include a home power management system 326. The home power management system 326, or home controller 135 in conjunction with the EM devices 304, may collect power consumption data on the circuits 308 (e.g., via EM devices 304) or device electrical usage data of various electronic devices within the home 130. The home power management system 326 may, for example, collect usage data for lights or appliances within the home 130, giving an indication of how much electricity the home 130 uses or how frequently occupants are at home. In some embodiments, the home 130 may include one or more smart plugs (not separately shown) which may be managed by home power management system 326, the smart speaker device 318, the smart home system 324, or otherwise by the systems 100 and 200 (e.g., for activating or deactivating devices plugged into the circuits 308 via the smart plugs, such as via 110-volt outlets).

The home power management system 326 may identify and provide details on what appliances or other consuming devices are within the home 130 (e.g., manufacturer make and model), thereby allowing the systems 100 and 200 to identify some property on the premises (e.g., device identification and verification, device count), evaluate value of devices (e.g., replacement costs), or collect manufacturer-provided or consumer protection-provided details regarding the devices from external data sources 215 (e.g., susceptibility of the device to power surges, likelihood of fire caused by the device, mean time to failure of the device, types of device failures, power consumption profiles and tolerances of the device, or the like).

The home power management system 326 may collect power quality data for the home 130, such as occurrences and frequency of power outages or reductions in service (e.g., black-outs or brown-outs), loading at various times throughout the day or week, the size of service, occurrences of voltage values fluctuating beyond tolerance ranges (e.g., spikes), or the like. In some embodiments, the home power management system 326 may include one or more smart circuit breakers (e.g., on any or all of the circuits 308) or a smart panel (e.g., as the electrical distribution panel 306), such as those made commercially available by Schneider Electric (Paris, France), which may provide circuit-level data and operations such as, for example, current or historical circuit load data, circuit breaker status, or turning circuit breakers on or off. Such power data may be used to construct a power profile for the home 130. In some embodiments, the home controller 135 may perform any such power monitoring and data collection operations in lieu of, or in addition to, the home power management system 326.

In the exemplary embodiment, the home 130 may include one or more smart appliances 312 (e.g., appliances that can communicate via the home network 205, which may include IoT devices 110). Smart appliances 312 may include, for example, dish washers, microwaves, stove tops, ovens, grills, clothes washers and dryers, water heater, water meter, water softener or purifier, smart lighting, smart window blinds or shutters, piping, interior or yard sprinklers, or the like. The home controller 135 may be configured to communicate with such smart appliances 312 and may collect home data from such appliances for the systems 100 and 200.

For example, smart appliances 312 may provide data such as device data (e.g., manufacturer, make, model, date of manufacturer, date of installation, software or firmware versions), usage data (e.g., daily usage time, power consumption), or log data (e.g., log events, alerts, component failure detections, maintenance history, or the like). Such appliance data may allow the systems 100 and 200 to detect which appliances are present in the home 130 (broadly, as a part of an “asset inventory” of the house), their replacement value, age of each appliance, a maintenance history of each appliance, to detect when appliances or their components are failing.

Electrical distribution system 300 may use such data, for example, to construct the power profile for home 130, to compute a risk for the home 130 and/or the appliances, to compute in an insurance profile for the home 130 (e.g., as factors of risk to lightning or other hazards), or to alert the homeowners when an appliance registers a failure.

In the exemplary embodiment, the home 130 may also include smart HVAC devices such as, for example, a heater (e.g., a gas or electric furnace), an air conditioner, an air purifier, an attic fan, a ceiling fan. Some or all such devices may be controlled by a thermostat device. Such devices are collectively referred to herein as HVAC devices 314, some of which may not be smart devices but may nonetheless be controlled in some aspects by the thermostat device.

The systems 100 and 200 may collect HVAC data such as device data (e.g., manufacturer, make, model, date of manufacturer, date of installation), usage data (e.g., daily usage time, power consumption), or thermostat data (e.g., temperature settings, daily schedule profiles). The systems 100 and 200 may use such data, for example, to construct the power profile for the home 130, to compute a risk for the home 130 (e.g., determining how often the home 130 is typically occupied), to compute in an insurance profile for the home (e.g., as factors of risk to lightning or other hazards, likelihood of equipment failures), or to alert the homeowners when an HVAC device registers a failure.

The home 130, in the exemplary embodiment, may also include various computing devices such as, for example, desktop or laptop personal computers, tablet computers, servers, or networking devices (e.g., Wi-Fi routers, switches, hubs, firewalls, or the like), all of which are collectively represented here as home network/computer devices (or just “computer devices”) 316. The networking devices may provide some or all of the home network 205 that is used to facilitate communication between the devices shown here. The home controller 135 may be configured to capture computer device data from some or all of these home network computer devices 316 such as, for example, a number and type of computing devices (e.g., hardware manufacturer, make, model, and the like), hardware and software profile of computing devices, configuration data of computing devices (e.g., software versions, firmware versions), usage data, and log data (e.g., firewall logs, access logs, software patch logs, error logs). The systems 100 and 200 may use such data to, for example, determine asset inventory and valuation, construct the power profile for the home 130 (e.g., average daily usage), alert the homeowners when devices need software or firmware upgrades (e.g., critical security alerts) or upon intrusion detection or other compromise of home network computer devices 316 (e.g., software hacks).

In the exemplary embodiment, the home 130 may include a smart speaker device(s) (or “nest device”) 318 that may interact with occupants of the home 130 (e.g., via audible commands and responses, digital display, executing pre-configured actions). Some example smart speaker devices 318 include the Echo® devices (Amazon Inc., of Seattle, Washington) and the Google Nest® devices (Alphabet Inc., of Mountain View, California), to name but a few. The smart speaker device 318 may include a speaker for providing audio output, a microphone for receiving audio input (e.g., commands spoken by the occupants), and may include a display device for video output or a camera device for capturing video input. The smart speaker device 318 may be configured to interact with other smart devices, such as for controlling lighting within the home 130, the thermostat (e.g., changing thermostat settings), home security devices of a home security system 320 (e.g., locking and unlocking smart locks on doors, opening or closing garage doors, or the like), or entertainment devices of a home entertainment system 326 (e.g., enabling, disabling, or reconfiguring music or television devices).

The systems 100 and 200 may, with owner configuration and permission, utilize inputs from the smart speaker device 318 to, for example, determine a number of unique occupants of the home 130 (e.g., via unique speech profile or video identification), determine the number of children in the home 130 (e.g., via audio or video analysis), determine when occupants of the home 130 are currently or historically present (e.g., via noise detection, video movement), determine when other devices are turned on or off, determine presence of pets (e.g., via unique audio sounds or video identification of the pets), or smoke or carbon monoxide alarm detection (e.g., via audible sound). Such raw data may be sanitized or distilled by the home controller 135 into refined data before sending to server computing device 150 in an effort to protect privacy of the home occupants while still providing home health evaluation and risk capabilities (e.g., sending results determined from the raw audio or video data and deleting the raw audio or video data). The systems 100 and 200 may anonymize personal data, thereby allowing data to be stored or used without direct attribution of data to a particular homeowner.

In the exemplary embodiment, the home 130 may include various home entertainment devices 320 such as, for example, televisions, digital video recorders (“DVR”), radios, amplifiers, speakers, remotes, or console gaming systems, any or all of which may be smart devices in communication with the home network 205 and home controller 135. Home controller 135 may collect home entertainment data from such devices and may use that data, for example, to construct the power profile for the home 130, to construct the asset inventory of the home 130, to compute a risk score for the home 130, to compute in an insurance profile for the home (e.g., as factors of risk to lightning or other hazards, likelihood of equipment failures).

The home 130, in the exemplary embodiment, may include a home security system 322. The home security system 322 may include security devices such as, for example, door or window sensors (e.g., to detect when doors or windows or open, when windows are broken), motion sensors (e.g., to detect when someone is present within range of the sensor), security cameras (e.g., for capturing audio/video of particular areas in or around the home 130, such as a doorbell camera), key pads (e.g., for enabling/disabling the security system), panic buttons (e.g., for alerting a security service or authorities of an emergency situation), security hubs (e.g., for integrating individual security devices into a security system, for centrally controlling such devices, for interacting with third parties), electric door locks, or smoke/fire/carbon monoxide detectors. Such “security devices” broadly represent devices that can detect potential contemporaneous risks to the home 130 or its occupants (e.g., intrusion, fire, health).

The home security system 322 may be configured to communicate with a third-party security service or local authorities, and may transmit alerts to such parties when events are detected. The home controller 135 may be configured to receive alert data from the home security system 322 and may transmit such alerts to server computing device 150, create historical logs of security events, or transmit alert events directly to the homeowner (e.g., via SMS text message or the like) or to local authorities, fire protection, or emergency services. The systems 100 and 200 may use such security alert events to, for example, determine how frequently security events occur (e.g., as a factor for risk), how often such events are warranted (e.g., authentic risks rather than false alarms), or the type and nature of such authentic risks or false alarms.

The systems 100 and 200 may use raw data collected directly from any of these security devices. For example, the home controller 135 may use raw data from the motion sensors to detect when the home 130 is occupied (e.g., to build a profile of occupancy times), may use raw data from the camera devices or door devices to detect when occupants enter or exit the home 130, may use the camera devices to determine a number of occupants of the home 130 or a number and type of pets in the home 130. The home controller 135 may determine information about the home security system 322 installed within the home, such as a number and type of security sensors installed within the home 130, a type of home security system 322 installed in the home (e.g., third-party service provider, device manufacturers, types of security protection implemented within the home), or how often the homeowners leave the home 130 unoccupied without activating the home security system 322 (e.g., as a factor in risk calculations or home health scoring). The systems 100 and 200 may rate the home security system 322 and associated devices and services to generate a home security protection rating (e.g., relative to other available security systems or hardware) and may use that rating as a factor in risk calculations or in preparing a risk mitigation proposal (e.g., for more or better devices or security systems).

In some embodiments, the home 130 may include a smart home system 324 (e.g., a home monitoring system) that allows the homeowner and occupants to control various devices within the home 130. For example, the smart home system 324 may be configured to control, inter alia, devices such as the smart appliances 312, HVAC devices 314, home entertainment devices 320, or home security system 322. In the exemplary embodiment, the home controller 135 may be configured to interact directly with such devices as described herein (“direct access”), or may be configured to perform some interactions and data collections with such devices through the smart home system 324 (“proxy access”). For example, any or all of the data collections or operations described herein may be performed by the smart home system 324 based upon commands received from the home controller 135, thereby allowing the systems 100 and 200 to perform such operations through the smart home system 324 acting as a proxy for some such operations.

In the exemplary embodiment, the home 130 may include a home car charging station 328 that may be used to recharge electric vehicles. The home car charging station 328 may draw power from one or more of the circuits 308 of the electrical distribution system 300 and may include an on-premise power source (e.g., solar panels, wind generator, or the like) or a dedicated battery bank (e.g., for storing excess power from the local energy source). The systems 100 and 200 may capture various charging station data from the home car charging station 328, from the circuits 308 used for home car charging station 328, or from the local power source device(s).

In the exemplary embodiment, the home 130 may include one or more smart alarms 330 that are configured to detect various conditions within the home 130 and may alert the homeowner or other occupants (e.g., via audible alarm, SMS text message, email, or the like). Smart alarms 330 may include, for example, smoke detectors, carbon monoxide detectors, carbon dioxide detectors, or indoor air quality (“IAQ”) monitors or systems that include sensors configured to, for example, detect dangerous conditions such as fire or buildup of carbon monoxide, the presence of dangerous pollutants such as radon or various volatile organic compounds (“VOC”), or collect various air quality data such as temperature and humidity. Smart alarms 330 may include water leak detectors or flood alarms that may be configured to detect the presence of water at various areas in the home 130, such as near HVAC equipment, water tanks, sump pumps, below showers or bathtubs, around basement perimeters, behind or within basement walls, or the like. Such water detectors may identify leaks within plumbing or appliances within the home 130 or ingress of water into the home 130 (e.g., rain water, flooding, failing sump pump, foundation cracks, or the like).

System 100 may collect alarm data from the smart alarms 330 and may perform automatic alerting based upon sensor events registered at such smart alarms 330 (e.g., alerting emergency services, homeowner, or the like, in an effort to protect life and property, mitigate damage, or such) or initiate automatic actions (e.g., shutting off water flow within the home 130, or within a particular segment of plumbing, via activating a smart water shut off valve, not separately shown). The systems 100 and 200 may identify the presence of such smart alarms 330 or shut off valves in the home 130 when configured to communicate with the smart alarms 330 and may automatically provide policy discounts when particular smart alarms 330 are detected as present or may include the presence or absence of such smart alarms 330 in the various aspects of home health scoring. Furthermore, server computing device 150 may be configured to provide marketplace suggestions of provides to assist with the issues that are associated with the alarms.

Data received from smart alarm 330 may be used to detect hazards or other abnormalities that may be correlated with a reduced energy efficiency of the powered appliances, a need to repair or replace certain IoT devices 110, and/or indicate a risk to home 130 or its assets. For example, if smart alarm 330 is triggered based upon poor air quality in home 130, it may be determined that there is an issue with certain appliances such as HVAC devices 314, fans, and/or air purifiers, which may be correlated with suboptimal energy efficiency.

### Exemplary External Data Sources

In the exemplary embodiment, and referring now to FIG. 2, the system 200 may collect various types of external data from external data sources 215 that may be used, for example, for evaluating home 130, or other various uses described herein. For example, the machine learning model or AI model may identify correlations between any of the data types described herein and alert conditions in a home, and therefore may use any of these data sources as factors in identifying alert conditions in a home. Some external data sources 215 may provide publicly available data, where other external data sources 215 may be private, third-party sources. External data sources 215 may include an insurance provider that provides insurance policies to the homeowner and various data available or otherwise collected by that insurance provider. In some embodiments, server computing device 150 may be operated by the insurance provider and the data may include data private to the insurance provider (e.g., customer data, policy information, or other proprietary information).

In the exemplary embodiment, one example external data source 215 is the NOAA or any of its various branches (e.g., the national weather service). The NOAA makes various weather data publicly available. As such, the system 200 may collect weather data from the NOAA. Such weather data may be refined to a particular geography, such as a state, county, city, or other geographic region. The system 200 may, for example, identify a geographic region of the home 130 and submit data queries to the NOAA for weather data specific to that geographic region. Such data queries may include requests for historical data such as average rainfall, storm occurrences, wind strengths, lightning strikes, temperatures, tornado events, or the like.

Data queries may include requests for forecast data such as severe watches warnings, tornado watches or warnings, flooding watches or warnings, precipitation predictions, wind predictions, lightning event predictions, blizzard warnings, or the like. Forecast data may be used to, for example, generate and send weather alerts to the homeowner or occupants of the home 130 or determine how frequently the home 130 experiences various warnings or alerts over time. In some embodiments, the machine learning model or AI model may identify correlations between weather data and certain conditions that may be present in home 130, and therefore may use such data as a factor in identifying such conditions.

In the exemplary embodiment, another example external data source 215 may be the U.S. Forest Service. The U.S. Forest Service maintains historical data related to forest fires and tracks active forest fires in the United States. As such, system 100 may collect forest fire data from the U.S. Forest Service. Such forest fire data may similarly be refined to a particular geography, such as a state, county, city, or other geographic region. The system 200 may, for example, collect historical forest fire data for the geographic region of the home 130, or may collect current forest fire data at or near the location of the home 130 (e.g., within a pre-defined distance from the home, within a distance from a projected path of the forest fire). System 200 may use current forest fire data to, for example, generate and send forest fire alerts to the homeowner or occupants of the home 130, or as factors in home health scoring. In some embodiments, the machine learning model or AI model may identify correlations between forest fire data and certain conditions that may be present in home 130, and therefore may use such data as a factor in identifying such conditions.

In the exemplary embodiment, another example external data source 215 may be municipal power utilities. Electrical distribution system 300 may access current or historical power network data provided by power utility companies in various localities, such as power generation performance statistics (e.g., generation and load statistics), power transmission and distribution statistics or power outage information (e.g., across the network, local to a distribution segment that services the home 130, consistencies of voltages, power sags, power surges, brown-outs or black-outs and associated frequencies or lengths of outages, or the like), lightning strike data affecting the power network, or electrical consumption data for the home 130 (e.g., current or historical power usage, local power generation provided back to the network). System 100 may use current power network data to, for example, generate and send alerts to the homeowner during power outages (e.g., as SMS text messages or emails that can be viewed on mobile computing devices), or as factors in identifying alert conditions in a home and/or generating recommendations. In some embodiments, the machine learning model or AI model may identify correlations between power network data and certain conditions that may be present in home 130, and therefore may use such data as a factor in identifying such conditions.

In the exemplary embodiment, another example external data source 215 may be third-party home data systems such as Multiple Listings Service (“MLS”), Zillow (www.zillow.com), or other Internet-accessible sources for property data. The system 200 may access such home data systems to collect construction details about the home 130 such as, for example, the age of the home, how many bedrooms and bathrooms the home 130 has, the type of any HVAC, the square footage of the home 130, the size of the property, market price of the home, whether the home 130 is constructed of wood, brick, concrete, or the like, the type and size of any garage, the quality of materials used to construct the home 130, whether the home 130 has a basement, the type, age, or condition of plumbing or wiring inside and outside the home 130, whether the home 130 has a pool and safety fence around the pool, the type of roofing, the floor plan, the architecture of the home 130 (e.g., ranch, two story, split foyer), the type of flooring, the type of exterior (e.g., wood, brick, siding), type of local power generation on the property (e.g., solar, wind, generator), number of fire places, type of fencing or gutters, whether the home 130 has a pool, sheds, patios, porches, or other exterior structures, whether the home 130 has outside doors having steps, type of ducting and insulation within the home 130, type of landscaping around the home 130, or mobility or accessibility options within the home 130.

Some home statistics data may include geographic data about the home 130 such as, for example, school district information (e.g., public school system, school ratings), utility providers available to at the location (e.g., electric, gas, sewer, waste, recycling, phone, Internet, television, fire, police, hospital, or other city services), proximity data to various services and amenities (e.g., distances from schools, parks, grocery, gas, library, or sources of entertainment), hazard data for the area (e.g., crime statistics, natural disaster statistics, ratings for emergency services). Some home statistics data may include historical data, such as price history (e.g., sales history, listings history), public tax history, insurance claims history, home warranty information, home inspection information, lease information (e.g., whether and how often the home 130 has been partially or fully rented or leased), or the like. Some home statistics data may include home data such as, for example, whether the home 130 is energy certified, type and size of power generation, home appliance or lighting energy certification data, or the like. In some embodiments, the machine learning model or AI model may identify correlations between property data and/or home statistics data and certain conditions that may be present in home 130, and therefore may use such data as a factor in identifying such conditions.

In the exemplary embodiment, another example external data source 215 may be an insurance provider or other service provider that has an economic or consumer relationship with the homeowner. The system 200 may access the service provider systems to collect demographic details about the home 130 and its occupants, such as, for example, names or ages of the occupants, education levels or occupations of the occupants, whether any of the occupants smoke, a family emergency plan, community engagement of the occupants, or whether a business is operated out of the home 130.

The service provider system may collect home maintenance data about the home 130 such as, for example, maintenance logs of operations performed on the home 130 (e.g., service calls, property damage and fixes, routine device maintenance, cleanings, bug or pest service, lawn or garden service, roofing replacement, or the like), equipment installations and removals, device warranty information, or home improvements (e.g., new deck, pool, room(s), interior or exterior painting or weather proofing, solar installation, water reclamation systems installation, room remodeling, or the like).

The service provider system may collect home configuration data about the home 130 such as, for example, whether GFCI outlets or LED lights are installed in the home 130, whether power strips supporting multiple devices are in use, whether the home 130 has exercise equipment, types of grills or fryers installed in the home 130, whether the home 130 includes particular safety equipment (e.g., smoke or carbon monoxide detectors, fire extinguishers, deadbolts on exterior doors, water sensors, sump pump, or the like), paint colors used on various walls of the home 130. In some embodiments, the machine learning model or AI model may identify correlations between maintenance data and certain conditions that may be present in home 130, and therefore may use such data as a factor in identifying such conditions.

In some embodiments, the service provider may be the operator of server computing device 150 and the homeowner may provide such data via an input interface (e.g., online questionnaire, user interface, service application, or the like, during participation in the home health system described herein). Collection and use of such data may be opted into by the homeowner on behalf of the occupants. In some embodiments, the system 200 may query the homeowner for any data elements described herein and not otherwise automatically accessed by the system 200.

In the exemplary embodiment, the system 200 may access aerial data of the home 130, such as satellite-, aerial-, or drone-captured overhead images of the home 130 and surrounding property. Such aerial data may be used to determine various externally visible features of home data (e.g., via digital image processing, machine learning, or human analysis). For example, system 200 may use aerial data to determine structural elements of the home 130 or surrounding property, such as whether the home 130 has a swimming pool, a fence, or a deck, how many garages the home 130 has, or the like. The system 200 may use aerial data to determine whether the home 130 has trees nearby (e.g., which may cause damage to the home 130) or whether the home 130 is located on a cul-de-sac or a busy road. Such aerial data may be provided by a third party or public external data source 215 (e.g., United States Geological Survey (“USGS”), National Aeronautics and Space Administration (“NASA”), NOAA, Google®, or the like) or may be privately collected (e.g., via aerial or drone photography of the home 130 by the insurance provider, realtor, or the like). Such aerial data may include global positioning system (“GPS”) location data for the home 130. In some embodiments, the machine learning model or AI model may identify correlations between aerial data and certain conditions that may be present in home 130, and therefore may use such data as a factor in identifying such conditions.

The system 200 may train a model of satellite images of homes 130 with labeled data of the homes 130 indicating, for example, whether the homes 130 have pools, decks, nearby trees, or other such features. As such, the trained model may be configured to automatically evaluate an unlabeled home (e.g., the home 130 in FIG. 1) to determine whether such features are present or otherwise categorize the home 130 with respect to those features.

In some embodiments, the system 200 may access mapping data around the home 130 to determine various home health features. The system 200 may utilize a web mapping service (e.g., Google® Maps or the like) as an external data source 215. For example, the system 200 may access the web mapping service via an application programming interface (“API”) that allows system 200 to submit, for example, the postal address of the home 130 or a GPS coordinate of the home 130 and query the web mapping service to provide features such as distances to nearby services (e.g., distance to nearest hospital, fire department, police station, schools, places of worship, parks, grocery stores, to various types of entertainment or other amenities, or the like).

Mapping data may be used to determine whether the home 130 is situated on a busy or isolated road. The system 200 may generate a play score for the home 130 using the mapping data, where the play score evaluates proximity of the home 130 to various types of entertainment or exercise venues, such as proximity to hiking trails, bike paths, sports fields, professional sports venues, restaurants, theaters, or the like).

The mapping data may include ground-level imagery provided by the web mapping service that may be used by the system 200 to evaluate various externally visible features of home data (e.g., via digital image processing, machine learning, or human analysis). For example, the system 200 may use ground-level imagery to determine structural features of the home 130 such as a number of stories of the home, type of windows installed in the home, a roof type or type of exterior of the home, or how many garages the home has. The system 200 may train a model of ground-level images of homes 130 with labeled data of the homes 130 indicating, for example, how many stories or garages the homes 130 have, what type of exterior or roof type the homes 130 have, or other such features. As such, the trained model may be configured to automatically evaluate an unlabeled home (e.g., the home 130 in FIG. 1) to determine whether such features are present or otherwise categorize the home 130 with respect to those features. In some embodiments, the machine learning model or AI model may identify correlations between mapping data and certain conditions that may be present in home 130, and therefore may use such data as a factor in identifying such conditions.

### Exemplary Server Computing Device

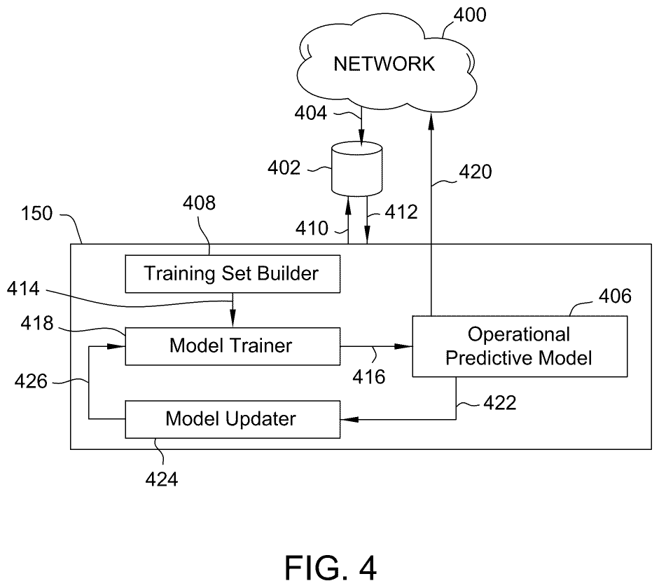

FIG. 4 is a schematic diagram illustrating further detail of server computing device 150 (shown in FIG. 1). Server computing device 150 may communicate with other components of system 100, such as manufacturer server 105, IoT devices 110, smart sensors 112, home controllers 135, and/or user devices 140, via a network 400. Server computing device may include and/or be in communication with a database 402 that stores data 404 including historical data and other information relevant to identifying alert conditions in home 130 and/or generating recommendations. Data 404 received from network 400 may be stored in database 402. Server computing device 150 may configured to use data 404 to generate an operational predictive model module 406 for generating comparison parameters and/or generating recommendations, as described above.

In exemplary embodiments, server computing device 150 includes a training set builder module 408 configured to submit one or more queries 410 to database 402 to retrieve subsets 412 of data 404, and to use those subsets 412 to build training data sets 414 for generating operational predictive model 206. For example, query 410 may be configured to retrieve certain fields from data 404 for homes (e.g., home 130) having certain similar aspects, such as similar sizes, ages, building materials, and/or locations.

In exemplary embodiments, training set builder module 408 may be configured to derive training data sets 414 from retrieved subsets 412. Each training data set 414 corresponds to a historical data 404 (“historical” in this context means completed in the past, as opposed to completed in real-time with respect to the time of retrieval by training set builder module 122). Each training data set 414 may include “model input” data fields along with at least one “result” data field representing historical feedback, such as reports relating to conditions of homes 130, feedback received from homeowners, and/or decisions made by homeowners based upon previous recommendations (e.g., whether homeowners performed recommended actions). The model input data fields represent factors that may be expected to, or unexpectedly be found during model training to, have some correlation certain conditions that may occur at home 130.

In exemplary embodiments, the model input data fields in training data sets 414 may be generated from data fields in subset 412 corresponding to historical data 404. In other words, a trained machine learning model 416 produced by a model trainer module 418 for use by operational predictive model module 406 is trained to make predictions based upon input values that can be generated from the data fields in data 404. Values in the model input data fields may include values copied directly from values in a corresponding data field in the retrieved subset 412, and/or values generated by modifying, combining, or otherwise operating upon values in one or more data fields in the retrieved subset 412. Values in the model input data fields may include sensor data and/or other types of home data. The use of such data fields as model input data fields facilitates the machine learning model in weighing these factors directly.

After training set builder module 408 generates training data sets 414, training set builder module 408 passes the training data sets 414 to model trainer module 418. In example embodiments, model trainer module 418 is configured to apply the model input data fields of each training data set 414 as inputs to one or more machine learning models. Each of the one or more machine learning models is programmed to produce, for each training data set 414, at least one output intended to correspond to, or “predict,” a value of the at least one result data field of the training data set 414. “Machine learning” refers broadly to various algorithms that may be used to train the model to identify and recognize patterns in existing data in order to facilitate making predictions for subsequent new input data.

Model trainer module 418 is configured to compare, for each training data set 414, the at least one output of the model to the at least one result data field of the training data set 414, and apply a machine learning algorithm to adjust parameters of the model in order to reduce the difference or “error” between the at least one output and the corresponding at least one result data field. In this way, model trainer module 418 trains the machine learning model to accurately predict the value of the at least one result data field. In other words, model trainer module 418 cycles the one or more machine learning models through the training data sets 414, causing adjustments in the model parameters, until the error between the at least one output and the at least one result data field falls below a suitable threshold, and then uploads at least one trained machine learning model 416 to operational predictive model module 406 for application to generating predictions 420. In exemplary embodiments, model trainer module 418 may be configured to simultaneously train multiple candidate machine learning models and to select the best performing candidate for each result data field, as measured by the “error” between the at least one output and the corresponding result data field, to upload to operational predictive model module 406.

In certain embodiments, the one or more machine learning models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer. As model trainer module 418 cycles through the training data sets 414, model trainer module 418 applies a suitable backpropagation algorithm to adjust the weights in each node layer to minimize the error between the at least one output and the corresponding result data field. In this fashion, the machine learning model is trained to produce output that reliably predicts the corresponding result data field. Alternatively, the machine learning model may have any suitable structure.

In some embodiments, model trainer module 418 provides an advantage by automatically discovering and properly weighting complex, second- or third-order, and/or otherwise nonlinear interconnections between the model input data fields and the at least one output. Absent the machine learning model, such connections are unexpected and/or undiscoverable by human analysts.

In exemplary embodiments, operational predictive model module 406 may compare feedback, and may route a comparison result 422 generated by comparing prediction 420 to the feedback to a model updater module 424 of server computing device 150. Model updater module 424 is configured to derive a correction signal 426 from comparison results 422 received for one or more predictions 420, and to provide correction signal 426 to model trainer module 418 to enable updating or “re-training” of the at least one machine learning model to improve performance. The retrained at least one machine learning model 416 may be periodically re-uploaded to operational predictive model module 406.

### Exemplary Computer System

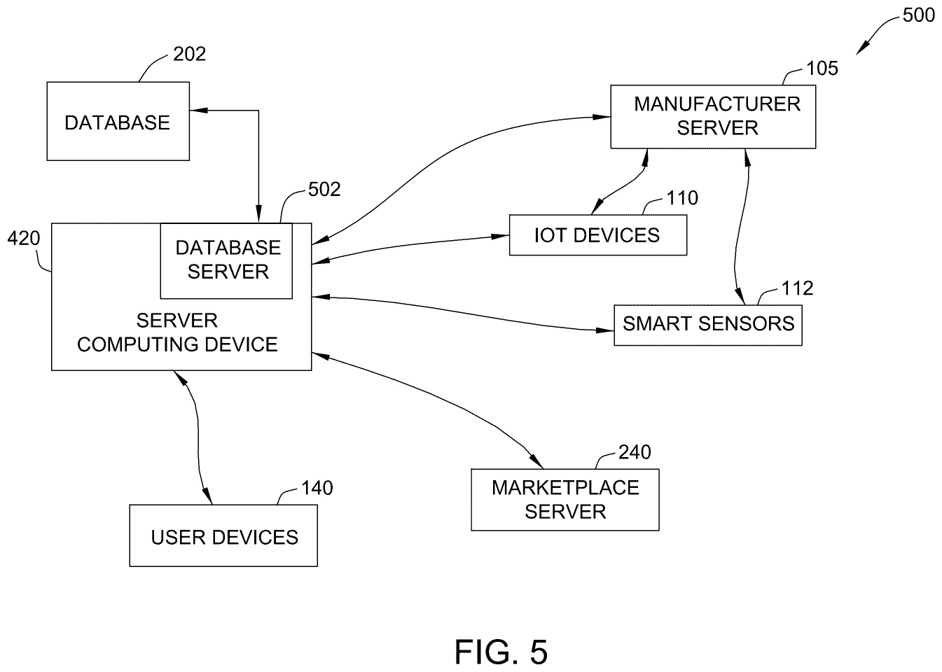

FIG. 5 illustrates an exemplary computer system 500 for implementing system 100 (shown in FIG. 1). In the exemplary embodiment, computer system 500 is used for analyzing sensor data associated with a home 130 (shown in FIG. 1) for home monitoring and/or generating recommendations for home 130.

In the exemplary embodiment, user devices 140 are computers that include a web browser or a software application, which enables user devices 140 to communicate with server computing device 150 using the Internet, a local area network (LAN), or a wide area network (WAN). In some embodiments, user devices 140 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. User devices 140 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the exemplary embodiment, IoT devices 110 and/or smart sensors 112 are computers that may include a web browser or a software application, which enables IoT devices 110 and/or smart sensors 112 to communicate with server computing device 150 using the Internet, a local area network (LAN), or a wide area network (WAN). In some embodiments, the IoT devices 110 and/or smart sensors 112 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. IoT devices 110 and/or smart sensors 112 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices. In the exemplary embodiment, IoT devices 110 and/or smart sensors 112 as devices connected to the home network 205 (shown in FIG. 2) that provide information about the home 130.

In the exemplary embodiment, manufacturer servers 105 are computers that may include a web browser or a software application, which enables manufacturer servers 105 to communicate with associated source IoT devices 110 and the server computing device 150 using the Internet, a local area network (LAN), or a wide area network (WAN). In some embodiments, the manufacturer servers 105 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The manufacturer servers 105 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the exemplary embodiment, marketplace servers 240 are computers that may include a web browser or a software application, which enables marketplace servers 240 to communicate with associated the server computing device 150 using the Internet, a local area network (LAN), or a wide area network (WAN). In some embodiments, the marketplace servers 240 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The marketplace servers 240 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the exemplary embodiment, server computing device 150 is a computer that may include a web browser or a software application, which enables server computing device 150 to communicate with user devices 140 using the Internet, a local area network (LAN), or a wide area network (WAN). In some embodiments, the server computing device 150 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The server computing device 150 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

A database server 502 is communicatively coupled to a database 402 that stores data. In one embodiment, the database 402 is a database that includes home data, sensor data, property data, and/or recommendations. In some embodiments, the database 402 is stored remotely from the server computing device 150. In some embodiments, the database 402 is decentralized. In the example embodiment, a person can access the database 402 via user devices 140 by logging onto server computing device 150. EXEMPLARY CLIENT DEVICE

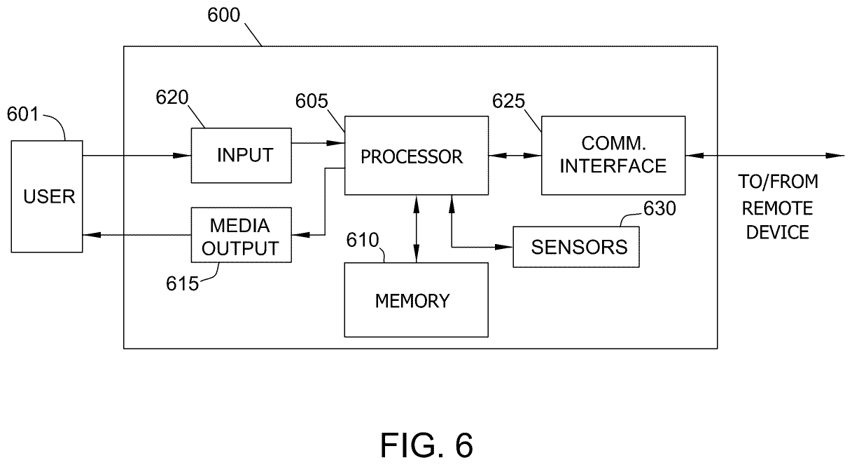

FIG. 6 depicts an exemplary configuration of a client computer device shown in FIG. 5, in accordance with one embodiment of the present disclosure. User computer device 602 may be operated by a user 601. User computer device 602 may include, but is not limited to, user device 140, IoT devices 110, smart sensors 112, IoT camera 115, IoT thermostat 120, IoT door lock 125, (all shown in FIG. 1), EM devices 304, HVAC devices 314, home network computer devices 316, smart speaker devices 318, home entertainment devices 320, home security system 322, smart home system 324, home power management system 326, and/or home car charging station 328 (all shown in FIG. 3). User computer device 602 may include a processor 605 for executing instructions. In some embodiments, executable instructions are stored in a memory area 610. Processor 605 may include one or more processing units (e.g., in a multi-core configuration). Memory area 610 may be any device allowing information such as executable instructions and/or transaction data to be stored and retrieved. Memory area 610 may include one or more computer-readable media.

User computer device 602 may also include at least one media output component 615 for presenting information to user 601. Media output component 615 may be any component capable of conveying information to user 601. In some embodiments, media output component 615 may include an output adapter (not shown) such as a video adapter and/or an audio adapter. An output adapter may be operatively coupled to processor 605 and operatively couplable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (eXtended Reality) headsets), and/or voice or chat bots.

In some embodiments, media output component 615 may be configured to present a graphical user interface (e.g., a web browser and/or a client application) to user 601. A graphical user interface may include, for example, an online score viewing interface for viewing a home health score and determining more information about the home health score. In some embodiments, user computer device 602 may include an input device 620 for receiving input from user 601. User 601 may use input device 620 to, without limitation, select a provider.

Input device 620 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 615 and input device 620.

User computer device 602 may also include a communication interface 625, communicatively coupled to a remote device such as the server computing device 150 (shown in FIG. 1) and/or the marketplace server 240 (shown in FIG. 2). Communication interface 625 may include, for example, a wired or wireless network adapter and/or a wireless data transceiver for use with a mobile telecommunications network.

Stored in memory area 610 are, for example, computer-readable instructions for providing a user interface to user 601 via media output component 615 and, optionally, receiving and processing input from input device 620. A user interface may include, among other possibilities, a web browser and/or a client application. Web browsers enable users, such as user 601, to display and interact with media and other information typically embedded on a web page or a website from the server computing device 150 and/or the marketplace server 240. A client application allows user 601 to interact with, for example, server computing device 150 and/or the marketplace server 240. For example, instructions may be stored by a cloud service, and the output of the execution of the instructions sent to the media output component 615.

Processor 605 executes computer-executable instructions for implementing aspects of the disclosure. In some embodiments, the processor 605 is transformed into a special purpose microprocessor by executing computer-executable instructions or by otherwise being programmed.

### Exemplary Server Device

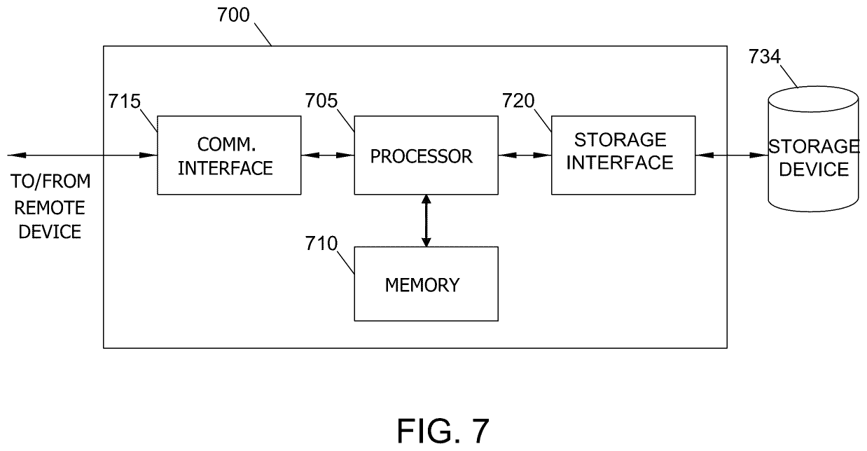

FIG. 7 depicts an exemplary configuration of a server computing device 700 shown in FIG. 1, in accordance with one embodiment of the present disclosure. Server computer device 700 may include, but is not limited to, home controller 135, server computing device 150 (shown in FIG. 1), external data sources 215, marketplace server 240 (both shown in FIG. 2), home security system 322, smart home system 324, and/or home power management system 326, (all shown in FIG. 3). Server computer device 700 may also include a processor 705 for executing instructions. Instructions may be stored in a memory area 710. Processor 705 may include one or more processing units (e.g., in a multi-core configuration).

Processor 705 may be operatively coupled to a communication interface 715 such that server computer device 700 is capable of communicating with a remote device such as another server computer device 700. For example, communication interface 715 may receive requests from user device 140 via the Internet, as illustrated in FIG. 5.

Processor 705 may also be operatively coupled to a storage device 734. Storage device 734 may be any computer-operated hardware suitable for storing and/or retrieving data, such as, but not limited to, data associated with database 402 (shown in FIG. 4). In some embodiments, storage device 734 may be integrated in server computer device 700. For example, server computer device 700 may include one or more hard disk drives as storage device 734.

In other embodiments, storage device 734 may be external to server computer device 700 and may be accessed by a plurality of server computer devices 700. For example, storage device 634 may include a storage area network (SAN), a network attached storage (NAS) system, and/or multiple storage units such as hard disks and/or solid state disks in a redundant array of inexpensive disks (RAID) configuration.

In some embodiments, processor 705 may be operatively coupled to storage device 634 via a storage interface 720. Storage interface 720 may be any component capable of providing processor 605 with access to storage device 734. Storage interface 720 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 705 with access to storage device 734.

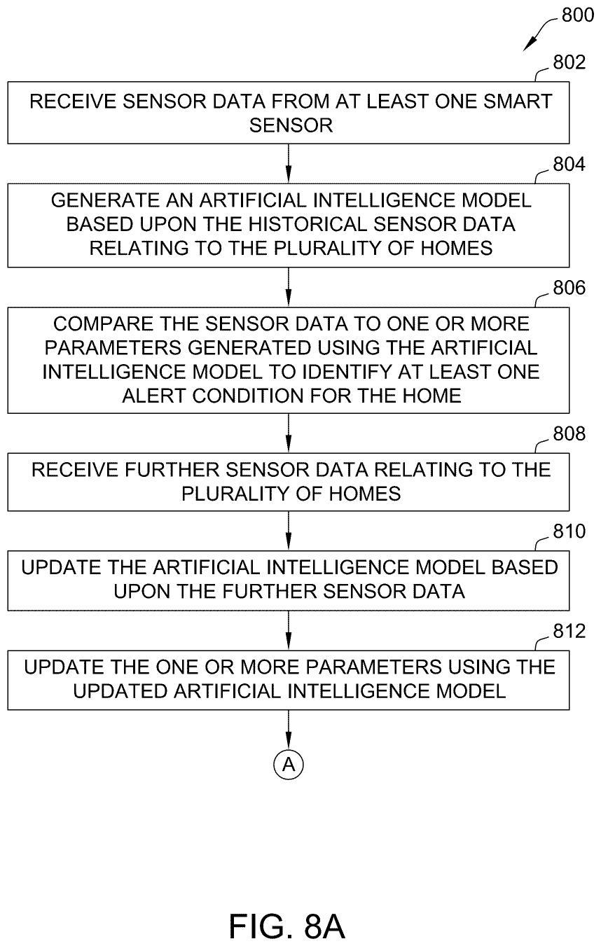

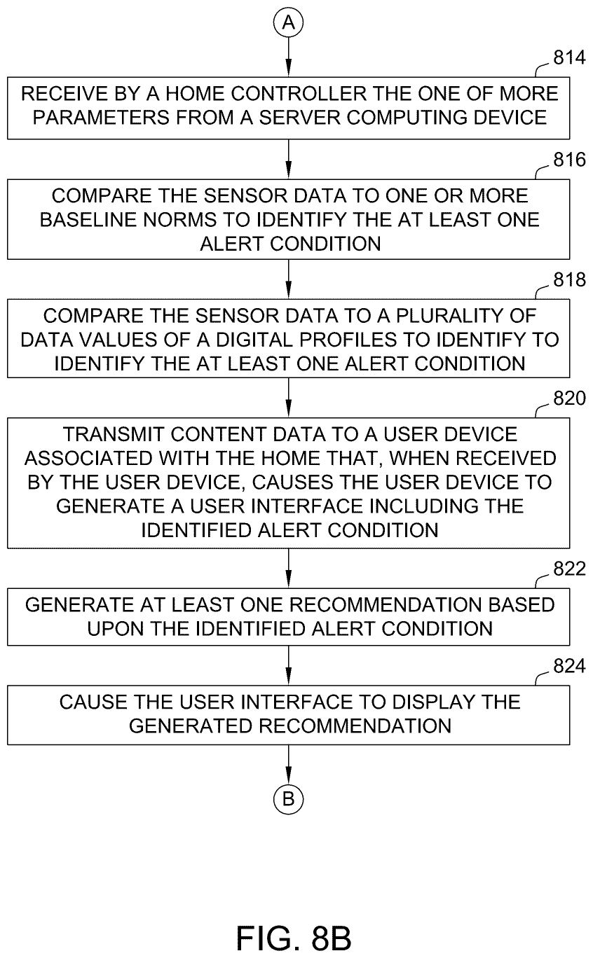

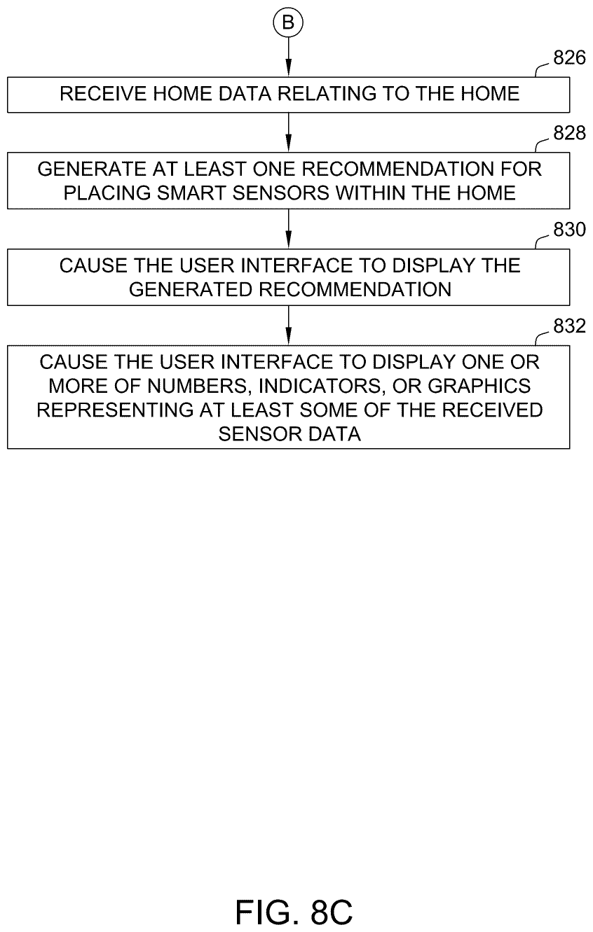

Processor 705 may execute computer-executable instructions for implementing aspects of the disclosure. In some embodiments, the processor 705 may be transformed into a special purpose microprocessor by executing computer-executable instructions or by otherwise being programmed. For example, the processor 705 may be programmed with the instructions such as illustrated in FIG. 8.

### Exemplary Computer-Implemented Method for Home Monitoring

FIGS. 8A, 8B, and 8C depict a flow chart of an exemplary computer-implemented method 800 for monitoring a home such as home 130 using system 100 (shown in FIG. 1).

In the exemplary embodiment, computer-implemented method 800 may include receiving sensor data from at least one smart sensor (Block 802). In some embodiments, the operations and/or functionality of Block 802 may be performed by server computing device 150 and/or home controller 135 (shown in FIG. 1).

In some embodiments, computer-implemented method 800 may further include generating an artificial intelligence model based upon historical sensor data relating to a plurality of homes (Block 804). In some embodiments, the operations and/or functionality of Block 804 may be performed by server computing device 150 and/or home controller 135 (shown in FIG. 1).

In the exemplary embodiment, computer-implemented method 800 may further include comparing the sensor data to one or more parameters generated using the artificial intelligence model to identify at least one alert condition for the home (Block 806). In some embodiments, the operations and/or functionality of Block 806 may be performed by server computing device 150 and/or home controller 135 (shown in FIG. 1).

In some embodiments, computer-implemented method 800 may further include receiving further sensor data relating to the plurality of homes (Block 808); updating the artificial intelligence model based upon the further sensor data (Block 810); and/or updating the one or more parameters using the updated artificial intelligence model (Block 812). In some embodiments, the operations and/or functionality of Blocks 808, 810, and/or 812 may be performed by server computing device 150 and/or home controller 135 (shown in FIG. 1).

In some embodiments, computer-implemented method 800 may further include receiving by a home controller the one or more parameters from a server computing device (Block 814). In some embodiments, the operations and/or functionality of Block 814 may be performed by server computing device 150 and/or home controller 135 (shown in FIG. 1).

In some embodiments, computer-implemented method 800 may further include comparing the sensor data to one or more baseline norms to identify the at least one alert condition (Block 816). In some embodiments, the operations and/or functionality of Block 816 may be performed by server computing device 150 and/or home controller 135 (shown in FIG. 1).

In some embodiments, computer-implemented method 800 may further includes comparing the sensor data to a plurality of data values of a digital profiles to identify the at least one alert condition (Block 818). In some embodiments, the operations and/or functionality of Block 818 may be performed by server computing device 150 and/or home controller 135 (shown in FIG. 1).

In the exemplary embodiment, computer-implemented method 800 may further include transmitting content data to a user device associated with the home that, when received by the user device, causes the user device to generate a user interface including the identified alert condition (Block 820). In some embodiments, the operations and/or functionality of Block 820 may be performed by server computing device 150 and/or home controller 135 (shown in FIG. 1).

In some embodiments, computer-implemented method 800 may further include generating (Block 822) at least one recommendation based upon the identified alert condition and causing (Block 824) the user interface to display the generated recommendation. In some embodiments, the operations and/or functionality of Blocks 822, 824 may be performed by server computing device 150 and/or home controller 135 (shown in FIG. 1).

In some embodiments, computer-implemented method 800 may further include receiving (Block 826) home data relating to the home; generating (Block 828) at least one recommendation for placing smart sensors within the home; and/or causing (Block 830) the user interface to display the generated recommendation. In some embodiments, the operations and/or functionality of Blocks 826, 828, and 830 may be performed by server computing device 150 and/or home controller 135 (shown in FIG. 1).

In some embodiments, computer-implemented method 800 may further include causing the user interface to display one or more of numbers, indicators, or graphics representing at least some of the received sensor data (Block 832). In some embodiments, the operations and/or functionality of Block 832 may be performed by server computing device 150 and/or home controller 135 (shown in FIG. 1).

### Exemplary Data Analysis Process for Home Monitoring

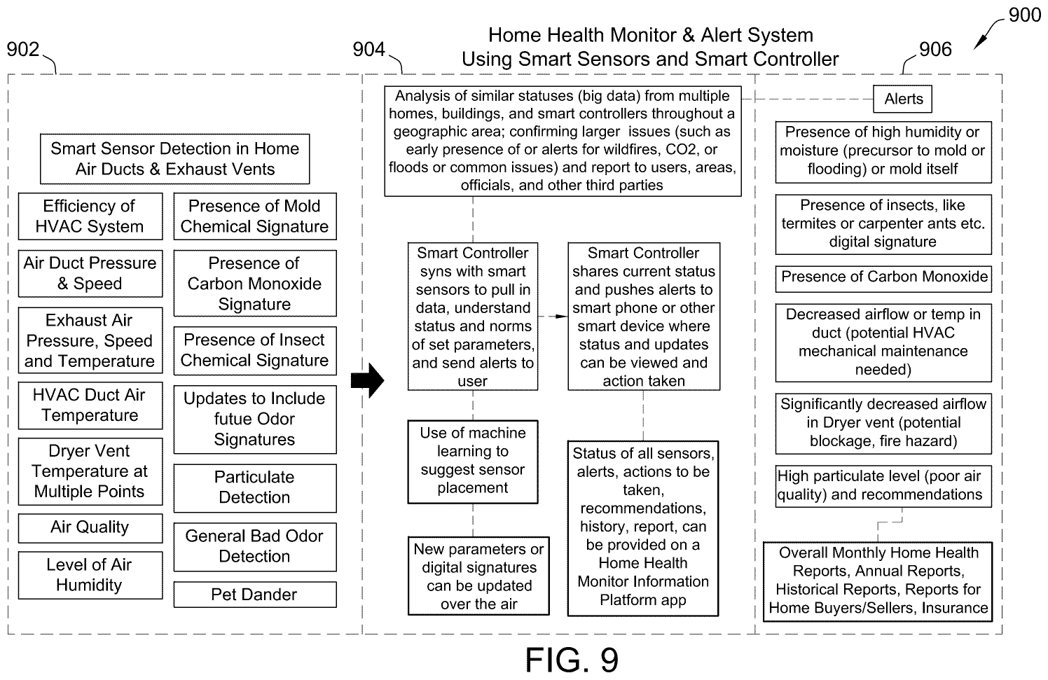

FIG. 9 is a diagram illustrating an exemplary data analysis process 900 for home monitoring that may be performed by system 100 (shown in FIG. 1), for example, using server computing device 150 and/or home controller 135.

Server computing device 150 and/or home controller 135 may collect various types of information 902, which may include, for example: (1) HVAC system efficiency; (2) air duct pressure and speed; (3) exhaust air pressure, speed, and temperature; (4) HVAC duct air temperature; (5) dryer vent temperature at one or more points; (6) air quality; (7) level of air humidity; (8) presence of mold chemical signature; (9) presence of carbon monoxide signature; (10) presence of insect chemical signature; (11) updates to include future and/or other odor signatures; (12) particulate detection; (13) general bad odor detection; and/or (14) pet dander.

Server computing device 150 and/or home controller 135 may generate, based on information 902, one or more data outputs 904, which may include, for example: (1) analysis of similar statuses (big data) from multiple home, buildings, and smart controllers throughout a geographic area, confirming larger issues (such as early presence of or alerts for wildfires, carbon dioxide or carbon monoxide, or foods or common issues) and report to users, areas, officials, and/or other third parties; (2) smart controller syncs with sensors to pull in data, understand status and norms of set parameters, and send alerts to user; (3) use of machine learning to suggest sensor placement; (4) new parameters and/or digital signatures can be updated over the air; (5) smart controller shares status and pushes alerts 906 to smart phone or other smart device where status and updates can be viewed and action taken; and/or (6) status of all sensors, alerts, actions to be taken, recommendations, history, reports, can be provided on a home health monitor information platform app.

Server computing device 150 and/or home controller 135 may generate one or more types of alerts 906, which may include, for example: (1) presence of high humidity or moisture (precursor to mold or flooding) or mold itself, (2) presence of digital signatures of insects, like termites or carpenter ants; (3) presence of carbon monoxide; (4) decreased airflow or temperature in duct (potential HVAC mechanical maintenance needed); (5) significantly decreased airflow in dryer vent (potential blockage, fire hazard); (6) high particulate level (poor air quality) and recommendations; and/or (7) overall monthly home health reports, annual reports, historical reports, reports for home buyers/sellers or insurance.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, server computing device 150 is configured to implement machine learning, such that server computing device 150 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of home attributes with known characteristics or features. Such information may include, for example, sensor data and/or information associated with a plurality of IoT devices 110.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments, and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

### EXEMPLARY EMBODIMENTS

In an exemplary embodiment, a computer system for home monitoring for a home may be provided. The computer system may include at least one memory device, at least one processor in communication with the at least one memory device, and at least one smart sensor for a home. The computer system may be programmed to: (a) receive sensor data from the at least one smart sensor; (b) compare the sensor data to one or more parameters generated using an artificial intelligence model to identify at least one alert condition for the home, wherein the artificial intelligence model is trained based upon historical sensor data relating to a plurality of homes; and/or (c) transmit content data to a user device associated with the home that, when received by the user device, causes the user device to generate a user interface including the identified alert condition. The computer system may include additional, less, or alternate functionality, including that discussed elsewhere herein.

In another exemplary embodiment, a computer-implemented method for home monitoring for a home may be provided. The computer-implemented method may be performed by a computing device including at least one processor and at least one memory device. The method may include, via the at least one processor: (a) receiving sensor data from the at least one smart sensor; (b) comparing the sensor data to one or more parameters generated using an artificial intelligence model to identify at least one alert condition for the home, wherein the artificial intelligence model is trained based upon historical sensor data relating to a plurality of homes; and/or (c) transmitting content data to a user device associated with the home that, when received by the user device, causes the user device to generate a user interface including the identified alert condition. The method may have additional, less, or alternate actions, including that discussed elsewhere herein.

In yet another exemplary embodiment, at least one non-transitory computer-readable medium having computer-executable instructions embodied thereon may be provided. When executed by at least one processor, the computer-executable instructions cause the at least one processor a to: (a) receive sensor data from the at least one smart sensor; (b) compare the sensor data to one or more parameters generated using an artificial intelligence model to identify at least one alert condition for the home, wherein the artificial intelligence model is trained based upon historical sensor data relating to a plurality of homes; and/or (c) transmit content data to a user device associated with the home that, when received by the user device, causes the user device to generate a user interface including the identified alert condition. The computer-readable medium may have instructions that direct additional, less, or alternate functionality, including that discussed elsewhere herein.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system for home monitoring, the computer system comprising at least one memory device, at least one processor in communication with the at least one memory device, and at least one smart sensor for a home, the at least one processor configured to:
receive sensor data from the at least one smart sensor;
compare the sensor data to one or more parameters generated using an artificial intelligence model to identify at least one alert condition for the home, wherein the artificial intelligence model is trained based upon historical sensor data relating to a plurality of homes; and
transmit content data to a user device associated with the home that, when received by the user device, causes the user device to generate a user interface including the identified at least one alert condition.

2. The computer system of claim 1, wherein the at least one processor is further configured to generate the artificial intelligence model based upon the historical sensor data relating to the plurality of homes.

3. The computer system of claim 2, wherein the at least one processor is further configured to:
receive further sensor data relating to the plurality of homes;
update the artificial intelligence model based upon the further sensor data; and
update the one or more parameters using the updated artificial intelligence model.

4. The computer system of claim 1, further comprising a home controller disposed in the home and including the at least one processor, wherein the at least one processor is further configured to receive the one or more parameters from a server computing device.

5. The computer system of claim 1, wherein the parameters include one or more baseline norms, and wherein the at least one processor is configured to compare the sensor data to the one or more baseline norms to identify the at least one alert condition.

6. The computer system of claim 1, wherein the parameters include one or more digital profiles including a plurality of data values corresponding to different types of sensor data, and wherein the at least one processor is configured to compare the sensor data to the plurality of data values of the digital profiles to identify the at least one alert condition.

7. The computer system of claim 1, wherein that at least one processor is further configured to:
generate at least one recommendation based upon the identified at least one alert condition; and
cause the user interface to display the generated at least one recommendation.

8. The computer system of claim 1, wherein the at least one processor is further configured to:
receive home data relating to the home;
generate at least one recommendation for placing smart sensors within the home; and
cause the user interface to display the generated at least one recommendation.

9. The computer system of claim 1, wherein the at least one processor is further configured to cause the user interface to display one or more of numbers, indicators, or graphics representing at least some of the received sensor data.

10. The computer system of claim 1, wherein the at least one smart sensor comprises one or more of airflow sensors, air quality sensors, chemical sensors, humidity sensors, moisture sensors, odor sensors, particulate matter sensors, pressure sensors, or temperature sensors.

11. The computer system of claim 1, wherein the at least one alert condition includes one or more of moisture, mold, animal pests, carbon monoxide, low airflow, duct blockage, high temperature, low temperature, or poor air quality.

12. A computer-implemented method for home monitoring performed by a computer system including at least one memory device and at least one processor in communication with the at least one memory device and at least one smart sensor of a home, the computer-implemented method comprising:
receiving sensor data from the at least one smart sensor;
comparing the sensor data to one or more parameters generated using an artificial intelligence model to identify at least one alert condition for the home, wherein the artificial intelligence model is trained based upon historical sensor data relating to a plurality of homes; and
transmitting content data to a user device associated with the home that, when received by the user device, causes the user device to generate a user interface including the identified at least one alert condition.

13. The computer-implemented method of claim 12, further comprising generating the artificial intelligence model based upon the historical sensor data relating to the plurality of homes.

14. The computer-implemented method of claim 13, further comprising:
receiving further sensor data relating to the plurality of homes;
updating the artificial intelligence model based upon the further sensor data; and
updating the one or more parameters using the updated artificial intelligence model.

15. The computer-implemented method of claim 12, wherein the computer system further includes a home controller disposed in the home and including the at least one processor, and wherein the computer-implemented method further comprises receiving the one or more parameters from a server computing device.

16. The computer-implemented method of claim 12, wherein the parameters include one or more baseline norms, and wherein the computer-implemented method further comprises comparing the sensor data to the one or more baseline norms to identify the at least one alert condition.

17. The computer-implemented method of claim 12, wherein the parameters include one or more digital profiles including a plurality of data values corresponding to different types of sensor data, and wherein the computer-implemented method further comprises comparing the sensor data to the plurality of data values of the digital profiles to identify the at least one alert condition.

18. The computer-implemented method of claim 12, further comprising
generate at least one recommendation based upon the identified at least one alert condition; and
cause the user interface to display the generated at least one recommendation.

19. The computer-implemented method of claim 12, further comprising:
receive home data relating to the home;
generate at least one recommendation for placing smart sensors within the home; and
cause the user interface to display the generated at least one recommendation.

20. The computer-implemented method of claim 12, further comprising causing the user interface to display one or more of numbers, indicators, or graphics representing at least some of the received sensor data.

21. The computer-implemented method of claim 12, wherein the at least one smart sensor includes one or more of airflow sensors, air quality sensors, chemical sensors, humidity sensors, moisture sensors, odor sensors, particulate matter sensors, pressure sensors, or temperature sensors.

22. The computer-implemented method of claim 12, wherein the at least one alert condition includes one or more of moisture, mold, animal pests, carbon monoxide, low airflow, duct blockage, high temperature, low temperature, or poor air quality.

23. At least one non-transitory computer-readable media having computer-executable instructions embodied thereon, wherein when executed by a computer system including at least one memory device and at least one processor in communication with the at least one memory device and at least one smart sensor of a home, the computer-executable instructions cause the at least one processor to:
receive sensor data from the at least one smart sensor;
compare the sensor data to one or more parameters generated using an artificial intelligence model to identify at least one alert condition for the home, wherein the artificial intelligence model is trained based upon historical sensor data relating to a plurality of homes; and
transmit content data to a user device associated with the home that, when received by the user device, causes the user device to generate a user interface including the identified at least one alert condition.
